(19) United States
(12) Patent Application Publication
(10) Pub. No.: US 2015/0111018 A1
(43) Pub. Date: Apr. 23, 2015

(54) LOW COST CARBON MATERIALS FOR THE CAPTURE OF CO2 AND H2S FROM VARIOUS ENVIRONMENTS

(71) Applicants: James M. Tour, Bellaire, TX (US); Desmond E. Schipper, Houston, TX (US); Chih-Chau Hwang, Spring, TX (US); Josiah Tour, Bellaire, TX (US); Almaz S. Jalilov, Houston, TX (US); Gedeng Ruan, Houston, TX (US)

(72) Inventors: James M. Tour, Bellaire, TX (US); Desmond E. Schipper, Houston, TX (US); Chih-Chau Hwang, Spring, TX (US); Josiah Tour, Bellaire, TX (US); Almaz S. Jalilov, Houston, TX (US); Gedeng Ruan, Houston, TX (US)

(73) Assignee: William Marsh Rice University, Houston, TX (US)

(21) Appl. No.: 14/458,802

(22) Filed: Aug. 13, 2014

Related U.S. Application Data
(60) Provisional application No. 61/865,323, filed on Aug. 13, 2013.
(60) Provisional application No. 62/001,552, filed on May 21, 2014.

(51) Int. Cl. B01D 53/04; B01J 20/30; B01J 20/20

(52) U.S. Cl. CPC B01D 53/04; B01J 20/20; B01J 20/3078; B01D 2253/102; B01D 2257/304; B01D 2257/504
USPC 428/219; 423/230; 423/445 R; 423/439; 502/417; 252/190; 546/256; 95/136; 95/139; 95/95; 95/106

(57) ABSTRACT

In some embodiments, the present disclosure pertains to methods of capturing a gas from an environment by associating the environment with a porous carbon material that includes, without limitation, protein-derived porous carbon materials, carbohydrate-derived porous carbon materials, cotton-derived porous carbon materials, fat-derived porous carbon materials, waste-derived porous carbon materials, asphalt-derived porous carbon materials, coal-derived porous carbon materials, coke-derived porous carbon materials, asphaltene-derived porous carbon materials, oil product-derived porous carbon materials, bitumen-derived porous carbon materials, tar-derived porous carbon materials, pitch-derived porous carbon materials, anthracite-derived porous carbon materials, melamine-derived porous carbon materials, and combinations thereof. In some embodiments, the associating results in sorption of gas components (e.g., CO₂, H₂S, and combinations thereof) to the porous carbon material. Additional embodiments of the present disclosure pertain to the porous carbon materials and methods of making the same.

### CROSS-REFERENCE TO RELATED APPLICATIONS

This application claims priority to U.S. Provisional Patent Application No. 61/865,323, filed on Aug. 13, 2013; and U.S. Provisional Patent Application No. 62/001,552, filed on May 21, 2014. The entirety of each of the aforementioned applications is incorporated herein by reference.

### STATEMENT REGARDING FEDERALLY SPONSORED RESEARCH

Not applicable.

### BACKGROUND

Current methods and materials for capturing CO₂ and H₂S from an environment suffer from numerous limitations, including low selectivity, limited sorption capacity, high sorbent costs, and stringent reaction conditions. The present disclosure addresses these limitations.

### SUMMARY

In some embodiments, the present disclosure pertains to methods of capturing a gas from an environment. In some embodiments, the methods include a step of associating the environment with a porous carbon material. In some embodiments, the associating results in sorption of gas components to the porous carbon material. In some embodiments, the sorbed gas components include at least one of CO₂, H₂S, and combinations thereof.

In some embodiments, the environment in which gas capture occurs is a pressurized environment. In some embodiments, the environment includes, without limitation, industrial gas streams, natural gas streams, natural gas wells, industrial gas wells, oil and gas fields, and combinations thereof.

In some embodiments, the sorbed gas components include CO₂. In some embodiments, the sorption of the CO₂ to the porous carbon material occurs selectively over hydrocarbons in the environment. In some embodiments, the CO₂ is converted to poly(CO₂) within the pores of the porous carbon materials. In some embodiments, the porous carbon material has a CO₂ sorption capacity of about 50 wt % to about 200 wt % of the porous carbon material weight.

In some embodiments, the sorbed gas components include H₂S. In some embodiments, the H₂S is converted within the pores of the porous carbon materials to at least one of elemental sulfur (S), sulfur dioxide (SO₂), sulfuric acid (H₂SO₄), and combinations thereof. In some embodiments, the formed elemental sulfur becomes impregnated with the porous carbon material. In some embodiments, captured H₂S remains intact within the porous carbon material. In some embodiments, the porous carbon material has a H₂S sorption capacity of about 50 wt % to about 300 wt % of the porous carbon material weight.

In some embodiments, the sorbed gas components include CO₂ and H₂S. In some embodiments, the sorption of H₂S and CO₂ to the porous carbon material occurs at the same time. In some embodiments, the sorption of CO₂ to the porous carbon material occurs before the sorption of H₂S to the porous carbon material. In some embodiments, the sorption of H₂S to the porous carbon material occurs before the sorption of CO₂ to the porous carbon material.

In some embodiments, the methods of the present disclosure also include a step of releasing captured gas components from the porous carbon material. In some embodiments, the releasing occurs by decreasing the pressure of the environment or heating the environment. In some embodiments, the releasing of sorbed CO₂ occurs by decreasing the pressure of the environment or placing the porous carbon material in a second environment that has a lower pressure than the environment where CO₂ capture occurred. In some embodiments, the releasing of sorbed H₂S occurs by heating the porous carbon material. In some embodiments, the releasing of the CO₂ occurs before the releasing of the H₂S.

In some embodiments, the methods of the present disclosure also include a step of disposing the released gas. In some embodiments, the methods of the present disclosure also include a step of reusing the porous carbon material after the releasing to capture additional gas components from an environment.

In some embodiments, the porous carbon material utilized for gas capture includes a plurality of pores. In some embodiments, the porous carbon material includes, without limitation, protein-derived porous carbon materials, carbohydrate-derived porous carbon materials, cotton-derived porous carbon materials, fat-derived porous carbon materials, waste-derived porous carbon materials, asphalt-derived porous carbon materials, coal-derived porous carbon materials, coke-derived porous carbon materials, asphaltene-derived porous carbon materials, oil product-derived porous carbon materials, bitumen-derived porous carbon materials, tar-derived porous carbon materials, pitch-derived porous carbon materials, anthracite-derived porous carbon materials, melamine-derived porous carbon materials, and combinations thereof.

In some embodiments, the porous carbon material includes asphalt-derived porous carbon materials. In some embodiments, the porous carbon material is carbonized. In some embodiments, the porous carbon material is reduced. In some embodiments, the porous carbon material is vulcanized. In some embodiments, the porous carbon material includes a plurality of nucleophilic moieties. In some embodiments, the nucleophilic moieties include, without limitation, oxygen-containing moieties, sulfur-containing moieties, metal-containing moieties, metal oxide-containing moieties, metal sulfide-containing moieties, nitrogen-containing moieties, phosphorous-containing moieties, and combinations thereof.

In some embodiments, the porous carbon materials have surface areas ranging from about 2,500 m²/g to about 3,000 m²/g. In some embodiments, the plurality of pores in the porous carbon material comprises diameters ranging from about 1 nm to about 10 nm, and volumes ranging from about 1 cm³/g to about 3 cm³/g. In some embodiments, the porous carbon material has a density ranging from about 0.3 g/cm³ to about 4 g/cm³.

Additional embodiments of the present disclosure pertain to the porous carbon materials used for gas capture. Further embodiments of the present disclosure pertain to methods of making the porous carbon materials of the present disclosure.

### DESCRIPTION OF THE FIGURES

FIG. 1 provides various schemes. FIG. 1A provides a scheme of a method of utilizing porous carbon materials to capture gas (e.g., carbon dioxide (CO₂) or hydrogen sulfide (H₂S)) from an environment (FIG. 1A). FIG. 1B provides a scheme of a method of forming porous carbon materials for gas capture.

FIG. 2 provides schematic illustrations of the preparation of asphalt-derived porous carbon materials (A-PCs). FIG. 2A provides a scheme of a method of preparing nitrogen-doped A-PCs (A-NPCs) and reduced A-NPCs (A-rNPC). FIG. 2B provides more detailed schemes of methods of preparing A-rNPCs, sulfur-doped APCs (A-SPC), and nitrogen-doped and sulfur doped APCs (A-NSPCs).

FIG. 3 provides nitrogen sorption isotherms for A-PC, A-NPC and A-rNPC.

FIG. 4 provides scanning electron microscopy (SEM) (FIG. 4A) and transmission electron microscopy (TEM) (FIG. 4B) images of A-PCs.

FIG. 5 provides high-resolution x-ray photoelectron spectroscopy (XPS) N1s spectra of A-NPCs and A-rNPCs. FIG. 5A provides XPS spectra of A-NPCs prepared at 500° C. (A-NPC-500), 600° C. (A-NPC-600), 700° C. (A-NPC-700) and 800° C. (A-NPC-800). FIG. 5B provides XPS spectra of A-rNPCs.

FIG. 6 provides a comparison of room temperature volumetric CO₂ uptake of A-PC, A-NPC and A-rNPC with the other porous carbon sorbents and the starting asphalt.

FIG. 7 provides data relating to the volumetric uptake of CO₂ on A-rNPC as a function of temperature at pressures that range from about 0-30 bar (FIG. 7A) and about 0-1 bar (FIG. 7B).

FIG. 8 provides data relating to the volumetric CO₂ and CH₄ uptake of A-rNPC (red) and A-SPC (blue) at 23° C.

FIG. 9 provides data relating to heat of CO₂ absorption as a function of the amount of CO₂ absorbed on A-rNPC.

FIG. 10 shows the results of TEM EDS elemental mapping of A-rNPCs after H₂S uptake under air treatment. FIG. 10A shows a TEM image of A-rNPC after H₂S uptake. FIG. 10B shows carbon element mapping of A-rNPCs after H₂S uptake. FIG. 10C shows sulfur elemental mapping of A-rNPCs after H₂S uptake.

FIG. 11 shows a thermogravimetric analysis (TGA) curve of A-rNPCs after H₂S uptake with exposure to air.

FIG. 12 provides a summary of the H₂S uptake capacity of A-rNPC under different conditions, and its comparison to the H₂S uptake capacity of Maxsorb®, a commercial high surface area carbonized material.

FIG. 13 provides comparative data relating to the CO₂ uptake capacities of A-rNPCs and A-NPCs.

FIG. 14 provides comparative data relating to the CO₂ uptake capacities of A-NSPCs and A-SPCs.

FIG. 15 provides schemes of CO₂ capture from materials relating to the formation of chemisorbed oxygen species on porous carbon materials as a result of their reaction with H₂S and O₂. The porous carbon material was first reacted with H₂S and air, and then thermalized with or without ammonia, and finally used for reversible CO₂ capture.

### DETAILED DESCRIPTION

It is to be understood that both the foregoing general description and the following detailed description are illustrative and explanatory, and are not restrictive of the subject matter, as claimed. In this application, the use of the singular includes the plural, the word “a” or “an” means “at least one”, and the use of “or” means “and/or”, unless specifically stated otherwise. Furthermore, the use of the term “including”, as well as other forms, such as “includes” and “included”, is not limiting. Also, terms such as “element” or “component” encompass both elements or components comprising one unit and elements or components that comprise more than one unit unless specifically stated otherwise.

The section headings used herein are for organizational purposes and are not to be construed as limiting the subject matter described. All documents, or portions of documents, cited in this application, including, but not limited to, patents, patent applications, articles, books, and treatises, are hereby expressly incorporated herein by reference in their entirety for any purpose. In the event that one or more of the incorporated literature and similar materials defines a term in a manner that contradicts the definition of that term in this application, this application controls.

Environmental and health concerns have been linked to carbon dioxide (CO₂) and hydrogen sulfide (H₂S) emission sources, such as industrial power plants, refineries and natural gas wells. Therefore, efficient CO₂ and H₂S capture from flue gases or other high pressure natural gas wells has been a primary approach in mitigating environmental and health risks. For instance, aqueous amine solvents and membrane technologies have been utilized for CO₂ capture. In addition, solid sorbents such as activated carbon, zeolites and metal organic frameworks have been utilized as alternative materials for capturing CO₂.

However, many of the aforementioned technologies suffer from numerous limitations. For instance, many CO₂ and H₂S capture technologies that utilize aqueous amine solutions are highly inefficient due to the high energy requirements for regeneration (e.g., 120° C.-140° C.). Moreover, many of the aqueous amine solutions lack selectivity for CO₂ over other gases, such as CH₄. Furthermore, the corrosive nature of aqueous amine solutions and their high regeneration temperatures make them further unsuitable for many gas capture applications, such as offshore use.

Solid CO₂ sorbents have shown many advantages over conventional separation technologies that utilize aqueous amine solvents. For instance, solid CO₂ sorbents have been shown to capture CO₂ under high pressure. Moreover, many solid CO₂ sorbents have lower regeneration energy requirements, higher CO₂ uptake capacities, selectivity over hydrocarbons, and ease of handling. Moreover, solid CO₂ sorbents have shown lower heat capacities, faster kinetics of sorption and desorption, and high mechanical strength. In addition, solid CO₂ sorbents have been utilized to capture and release CO₂ without significant pressure and temperature swings.

However, a limitation of many solid CO₂ sorbents is the cost of production. Many solid CO₂ sorbents are also unable to compress and separate CO₂ from the sorbents in an efficient manner. Moreover, the H₂S sorption capacities of many solid CO₂ sorbents have not been ascertained. Therefore, a need exists for the development of more effective and affordable CO₂ and H₂S sorbents. A need also exists for more effective methods of utilizing such sorbents to capture CO₂ and H₂S from various environments.

In some embodiments illustrated in FIG. IA, the present disclosure pertains to methods of capturing a gas from an environment. In some embodiments, the method includes associating the environment with a porous carbon material (step 10) to result in sorption of gas components (e.g., CO₂, H₂S, and combinations thereof) to the porous carbon material (step 12). In some embodiments, the methods of the present disclosure also include a step of releasing the gas components from the porous carbon material (step 14). In some embodiments, the methods of the present disclosure also include a step of reusing the porous carbon material after the release of the gas components (step 16). In some embodiments, the methods of the present disclosure also include a step of disposing the released gas components (step 18). In some embodiments, the porous carbon material includes asphalt derived porous carbon materials.

As set forth in more detail herein, the gas capture methods and porous carbon materials of the present disclosure have numerous embodiments. For instance, various methods may be utilized to associate various types of porous carbon materials with various environments to result in the capture of various gas components from the environment. Moreover, the captured gas components may be released from the porous carbon materials in various manners.

Environments

The methods of the present disclosure may be utilized to capture gas from various environments. In some embodiments, the environment includes, without limitation, industrial gas streams, natural gas streams, natural gas wells, industrial gas wells, oil and gas fields, and combinations thereof. In some embodiments, the environment is a subsurface oil and gas field. In more specific embodiments, the methods of the present disclosure may be utilized to capture gas from an environment that contains natural gas, such as an oil well.

In some embodiments, the environment is a pressurized environment. For instance, in some embodiments, the environment has a total pressure higher than atmospheric pressure.

In some embodiments, the environment has a total pressure of about 0.1 bar to about 500 bar. In some embodiments, the environment has a total pressure of about 5 bar to about 100 bar. In some embodiments, the environment has a total pressure of about 25 bar to about 30 bar. In some embodiments, the environment has a total pressure of about 100 bar to about 200 bar. In some embodiments, the environment has a total pressure of about 200 bar to about 300 bar.

Gas Components

The methods of the present disclosure may be utilized to capture various gas components from an environment. For instance, in some embodiments, the captured gas component includes, without limitation, CO₂, H₂S, and combinations thereof. In some embodiments, the captured gas component includes CO₂. In some embodiments, the captured gas component includes H₂S. In some embodiments, the captured gas component includes CO₂ and H₂S.

Association of Porous Carbon Materials with an Environment

Various methods may be utilized to associate porous carbon materials of the present disclosure with an environment. In some embodiments, the association occurs by incubating the porous carbon materials with the environment (e.g., a pressurized environment). In some embodiments, the association of porous carbon materials with an environment occurs by flowing the environment through a structure that contains the porous carbon materials. In some embodiments, the structure may be a column or a sheet that contains immobilized porous carbon materials. In some embodiments, the structure may be a floating bed that contains porous carbon materials.

In some embodiments, the porous carbon materials are suspended in a solvent while being associated with an environment. In some embodiments, the solvent may include water or alcohol. In some embodiments, the porous carbon materials are associated with an environment in pelletized form. In some embodiments, the pelletization can be used to assist flow of the gas component through the porous carbon materials.

In some embodiments, the associating occurs by placing the porous carbon material at or near the environment. In some embodiments, such placement occurs by various methods that include, without limitation, adhesion, immobilization, clamping, and embedding. Additional methods by which to associate porous carbon materials with an environment can also be envisioned.

Gas Sorption to Porous Carbon Materials

The sorption of gas components (e.g., CO₂, H₂S, and combinations thereof) to porous carbon materials of the present disclosure can occur at various environmental pressures. For instance, in some embodiments, the sorption of gas components to porous carbon materials occurs above atmospheric pressure. In some embodiments, the sorption of gas components to porous carbon materials occurs at total pressures ranging from about 0.1 bar to about 500 bar. In some embodiments, the sorption of gas components to porous carbon materials occurs at total pressures ranging from about 5 bar to about 500 bar. In some embodiments, the sorption of gas components to porous carbon materials occurs at total pressures ranging from about 5 bar to about 100 bar. In some embodiments, the sorption of gas components to porous carbon materials occurs at total pressures ranging from about 25 bar to about 30 bar. In some embodiments, the sorption of gas components to porous carbon materials occurs at total pressures ranging from about 100 bar to about 500 bar. In some embodiments, the sorption of gas components to porous carbon materials occurs at total pressures ranging from about 100 bar to about 300 bar. In some embodiments, the sorption of gas components to porous carbon materials occurs at total pressures ranging from about 100 bar to about 200 bar.

The sorption of gas components to porous carbon materials can also occur at various temperatures. For instance, in some embodiments, the sorption of gas components to porous carbon materials occurs at temperatures that range from about 0° C. (e.g., a sea floor temperature where a wellhead may reside) to about 100° C. (e.g., a temperature where machinery may reside). In some embodiments, the sorption of gas components to porous carbon materials occurs at ambient temperature (e.g., temperatures ranging from about 20-25° C., such as 23° C.). In some embodiments, the sorption of gas components to porous carbon materials occurs below ambient temperature. In some embodiments, the sorption of gas components to porous carbon materials occurs above ambient temperature. In some embodiments, the sorption of gas components to porous carbon materials occurs without the heating of the porous carbon materials.

Without being bound by theory, it is envisioned that the sorption of gas components to porous carbon materials occurs by various molecular interactions between gas components (e.g., CO₂ or H₂S) and the porous carbon materials. For instance, in some embodiments, the sorption of gas components to porous carbon materials occurs by at least one of absorption, adsorption, ionic interactions, physisorption, chemisorption, covalent bonding, non-covalent bonding, hydrogen bonding, van der Waals interactions, acid-base interactions, and combinations of such mechanisms. In some embodiments, the sorption includes an absorption interaction between gas components (e.g., CO₂ or H₂S) in an environment and the porous carbon materials. In some embodiments, the sorption includes an ionic interaction between the gas components in an environment and the porous carbon materials. In some embodiments, the sorption includes an adsorption interaction between the gas components in an environment and the porous carbon materials. In some embodiments, the sorption includes a physisorption interaction between the gas components in an environment and the porous carbon materials. In some embodiments, the sorption includes a chemisorption interaction between the gas components in an environment and the porous carbon materials. In some embodiments, the sorption includes a covalent bonding interaction between the gas components in an environment and the porous carbon materials. In some embodiments, the sorption includes a non-covalent bonding interaction between the gas components in an environment and the porous carbon materials. In some embodiments, the sorption includes a hydrogen bonding interaction between the gas components in an environment and the porous carbon materials. In some embodiments, the sorption includes a van der Waals interaction between the gas components in an environment and the porous carbon materials. In some embodiments, the sorption includes an acid-base interaction between the gas components in an environment and the porous carbon materials. In some embodiments, the sorption of gas components to porous carbon materials occurs by adsorption and absorption.

CO₂ Sorption

In some embodiments, the sorption of gas components to porous carbon materials includes the sorption of CO₂ to the porous carbon materials. In some embodiments, the sorption of CO₂ to porous carbon materials occurs at a partial CO₂ pressure of about 0.1 bar to about 100 bar. In some embodiments, the sorption of CO₂ to porous carbon materials occurs at a partial CO₂ pressure of about 5 bar to about 30 bar. In some embodiments, the sorption of CO₂ to porous carbon materials occurs at a partial CO₂ pressure of about 30 bar.

Without being bound by theory, it is envisioned that CO₂ sorption may be facilitated by various chemical reactions. For instance, in some embodiments, the sorbed CO₂ is converted to poly(CO₂) within the pores of the porous carbon materials. In some embodiments, the poly(CO₂) comprises the following formula: —(O—C(═O))ₙ—, where n is equal to or greater than 2. In some embodiments, n is between 2 to 10,000. In some embodiments, the formed poly(CO₂) may be further stabilized by van der Waals interactions with the carbon surfaces in the pores of the carbon materials. In some embodiments, the formed poly(CO₂) may be in solid form.

In some embodiments, the sorption of CO₂ to the porous carbon materials occurs selectively. For instance, in some embodiments, the sorption of CO₂ to the porous carbon materials occurs selectively over hydrocarbons in the environment (e.g., ethane, propane, butane, pentane, methane, and combinations thereof). In further embodiments, the molecular ratio of sorbed CO₂ to sorbed hydrocarbons in the porous carbon materials is greater than about 2. In additional embodiments, the molecular ratio of sorbed CO₂ to sorbed hydrocarbons in the porous carbon materials ranges from about 2 to about 5. In additional embodiments, the molecular ratio of sorbed CO₂ to sorbed hydrocarbons in the porous carbon materials is about 3.5.

In more specific embodiments, the sorption of CO₂ to porous carbon materials occurs selectively over the CH₄ in the environment. In further embodiments, the molecular ratio of sorbed CO₂ to sorbed CH₄ (n_{CO2}/n_{CH4}) in the porous carbon materials is greater than about 2. In additional embodiments, n_{CO2}/n_{CH4} in the porous carbon materials ranges from about 2 to about 5. In more specific embodiments, n_{CO2}/n_{CH4} in the porous carbon materials is about 3.5.

In some embodiments, sorption of CO₂ to porous carbon materials occurs selectively through poly(CO₂) formation within the pores of the porous carbon materials. Without being bound by theory, it is envisioned that poly(CO₂) formation within the pores of the porous carbon materials can displace other gas components associated with the porous carbon materials, including any physisorbed gas components and hydrocarbons (e.g., methane, propane, and butane). Without being bound by further theory, it is also envisioned that the displacement of other gas components from the porous carbon materials creates a continual CO₂ selectivity that far exceeds various CO₂ selectively ranges, including the CO₂ selectivity ranges noted above.

In some embodiments, the covalent bond nature of poly(CO₂) within the pores of the porous carbon materials can be 100 times stronger than that of other physisorbed entities, including physisorbed gas components within the pores of the porous carbon materials. Therefore, such strong covalent bonds can contribute to the displacement of the physisorbed gas components (e.g., methane, propane and butane).

H₂S Sorption

In some embodiments, the sorption of gas components to porous carbon materials includes the sorption of H₂S to the porous carbon materials. In some embodiments, the sorption of H₂S to porous carbon materials occurs at a partial H₂S pressure of about 0.1 bar to about 100 bar. In some embodiments, the sorption of H₂S to porous carbon materials occurs at a partial H₂S pressure of about 5 bar to about 30 bar. In some embodiments, the sorption of H₂S to porous carbon materials occurs at a partial H₂S pressure of about 30 bar.

Without being bound by theory, it is envisioned that H₂S sorption may be facilitated by various chemical reactions. For instance, in some embodiments, sorbed H₂S may be converted within the pores of the porous carbon materials to at least one of elemental sulfur (S), sulfur dioxide (SO₂), sulfuric acid (H₂SO₄), and combinations thereof. In some embodiments, the aforementioned conversion can be facilitated by the presence of oxygen. For instance, in some embodiments, the introduction of small amounts of oxygen into a system containing porous carbon materials can facilitate the conversion of H₂S to elemental sulfur. In some embodiments, the oxygen can be introduced either continuously or periodically. In some embodiments, the oxygen can be introduced from air.

In some embodiments, the captured H₂S is converted by catalytic oxidation to elemental sulfur at ambient temperature. Thereafter, further oxidation to SO₂ and H₂SO₄ occurs at higher temperatures.

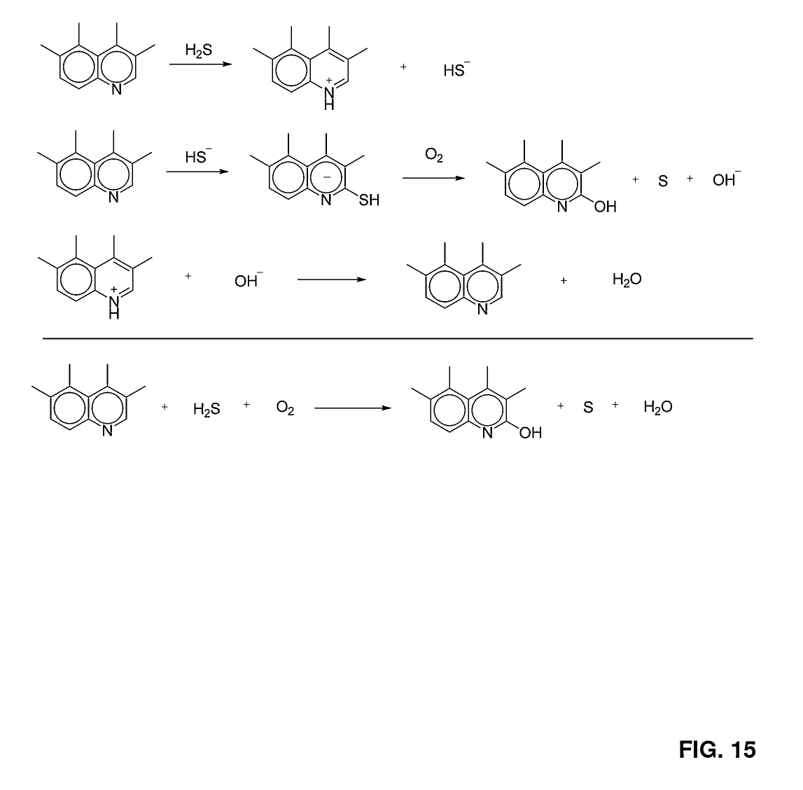

In some embodiments, nitrogen groups of porous carbon materials may facilitate the conversion of H₂S to elemental sulfur. For instance, in some embodiments illustrated in the schemes in FIG. 15, nitrogen functional groups on porous carbon materials may facilitate the dissociation of H₂S to HS⁻. In some embodiments, the nitrogen functional groups may also facilitate the formation of chemisorbed oxygen species (Seredych, M.; Bandosz, T. J. J. Phys. Chem. C 2008, 112, 4704-4711).

In some embodiments, the porous carbon material becomes impregnated with the sulfur derived from captured H₂S to form sulfur-impregnated porous carbon materials. In some embodiments, the formation of sulfur-impregnated porous carbon materials may be facilitated by heating. In some embodiments, the heating occurs at temperatures higher than H₂S capture temperatures. In some embodiments, the heating occurs in the absence of oxygen. In some embodiments, the sulfur impregnated porous carbon material can be used to efficiently capture CO₂ by the aforementioned methods.

In some embodiments, the sorption of H₂S to porous carbon materials occurs in intact form. In some embodiments, the sorption of H₂S to porous carbon materials in intact form occurs in the absence of oxygen.

CO₂ and H₂S Sorption

In some embodiments, the sorption of gas components to porous carbon materials includes the sorption of both H₂S and CO₂ to the porous carbon materials. In some embodiments, the sorption of H₂S and CO₂ to the porous carbon material occurs at the same time.

In some embodiments, the sorption of CO₂ to the porous carbon material occurs before the sorption of H₂S to the porous carbon material. For instance, in some embodiments, a gas containing CO₂ and H₂S flows through a structure that contains porous carbon materials (e.g., trapping cartridges). CO₂ is first captured from the gas as the gas flows through the structure. Thereafter, H₂S is captured from the gas as the gas continues to flow through the structure.

In some embodiments, the sorption of H₂S to the porous carbon material occurs before the sorption of CO₂ to the porous carbon material. For instance, in some embodiments, a gas containing CO₂ and H₂S flows through a structure that contains porous carbon materials (e.g., trapping cartridges). H₂S is first captured from the gas as the gas flows through the structure. Thereafter, CO₂ is captured from the gas as the gas continues to flow through the structure.

In some embodiments, the porous carbon materials that capture H₂S from the gas include nitrogen-containing porous carbon materials, as described in more detail herein. In some embodiments, the porous carbon materials that capture CO₂ from the gas include sulfur-containing porous carbon materials that are also described in more detail herein.

Release of Captured Gas

In some embodiments, the methods of the present disclosure also include a step of releasing captured gas components from porous carbon materials. Various methods may be utilized to release captured gas components from porous carbon materials. For instance, in some embodiments, the releasing occurs by decreasing the pressure of the environment. In some embodiments, the pressure of the environment is reduced to atmospheric pressure or below atmospheric pressure. In some embodiments, the releasing occurs by placing the porous carbon material in a second environment that has a lower pressure than the environment where gas capture occurred. In some embodiments, the second environment may be at or below atmospheric pressure. In some embodiments, the releasing occurs spontaneously as the environmental pressure decreases.

The release of captured gas components from porous carbon materials can occur at various pressures. For instance, in some embodiments, the release occurs at or below atmospheric pressure. In some embodiments, the release occurs at total pressures ranging from about 0 bar to about 100 bar. In some embodiments, the release occurs at total pressures ranging from about 0.1 bar to about 50 bar. In some embodiments, the release occurs at total pressures ranging from about 0.1 bar to about 30 bar. In some embodiments, the release occurs at total pressures ranging from about 0.1 bar to about 10 bar.

The release of captured gas components from porous carbon materials can also occur at various temperatures. In some embodiments, the releasing occurs at ambient temperature. In some embodiments, the releasing occurs at the same temperature at which gas sorption occurred. In some embodiments, the releasing occurs without heating the porous carbon materials. Therefore, in some embodiments, a temperature swing is not required to release captured gas components from porous carbon materials.

In some embodiments, the releasing occurs at temperatures ranging from about 30° C. to about 200° C. In some embodiments, the releasing is facilitated by also lowering the pressure.

In some embodiments, the releasing occurs by heating the porous carbon materials. For instance, in some embodiments, the releasing occurs by heating the porous carbon materials to temperatures between about 50° C. to about 200° C. In some embodiments, the releasing occurs by heating the porous carbon materials to temperatures between about 75° C. to about 125° C. In some embodiments, the releasing occurs by heating the porous carbon materials to temperatures ranging from about 50° C. to about 100° C. In some embodiments, the releasing occurs by heating the porous carbon materials to a temperature of about 90° C.

In some embodiments, heat for release of gas components from porous carbon materials can be supplied from various sources. For instance, in some embodiments, the heat for the release of gas components from a porous carbon material-containing vessel can be provided by an adjacent vessel whose heat is being generated during a gas sorption step.

In some embodiments, the release of captured gas components from an environment includes the release of captured CO₂ from porous carbon materials. Without being bound by theory, it is envisioned that the release of captured CO₂ from porous carbon materials can occur by various mechanisms. For instance, in some embodiments, the release of captured CO₂ can occur through a depolymerization of the formed poly(CO₂) within the pores of the porous carbon materials. In some embodiments, the depolymerization can be facilitated by a decrease in environmental pressure. In some embodiments, the releasing of the CO₂ occurs by decreasing the pressure of the environment or placing the porous carbon material in a second environment that has a lower pressure than the environment where CO₂ capture occurred.

In some embodiments, the release of captured gas components from an environment includes the release of captured H₂S from porous carbon materials. In some embodiments, the captured H₂S is released in intact form.

In some embodiments, H₂S is released from porous carbon materials by heating the porous carbon materials. In some embodiments, H₂S is released from porous carbon materials by heating the porous carbon materials to temperatures that range from about 50° C. to about 200° C. In some embodiments, H₂S is released from the porous carbon materials by heating the porous carbon materials to temperatures between about 75° C. to about 125° C. In some embodiments, H₂S is released from the porous carbon materials by heating the porous carbon materials to temperatures between about 50° C. to about 100° C. In some embodiments, H₂S is released from the porous carbon materials by heating the porous carbon materials to a temperature of about 90° C.

In some embodiments, the release of captured H₂S can occur through conversion of H₂S to at least one of elemental sulfur (S), sulfur dioxide (SO₂), sulfuric acid (H₂SO₄), and combinations thereof. In some embodiments, elemental sulfur is retained on the porous carbon material to form sulfur-impregnated porous carbon materials. In some embodiments, the sulfur-containing porous carbon material can be discarded through incineration or burial. In some embodiments, the sulfur-impregnated porous carbon material can be used for the reversible capture of CO₂.

In some embodiments, the release of captured gas components can occur in a sequential manner. For instance, in some embodiments where the sorbed gas components include both CO₂ and H₂S, the releasing of the CO₂ occurs by decreasing the pressure of the environment or placing the porous carbon material in a second environment that has a lower pressure than the environment where CO₂ capture occurred. In some embodiments, the releasing of the H₂S occurs by heating the porous carbon material (e.g., at temperatures ranging from about 50° C. to about 100° C.). In some embodiments, the releasing of the CO₂ occurs before the releasing of the H₂S. In some embodiments, the releasing of the H₂S occurs before the releasing of the CO₂. In some embodiments, the releasing of H₂S occurs in an environment that lacks oxygen.

Disposal of the Released gas

In some embodiments, the methods of the present disclosure also include a step of disposing the released gas components. For instance, in some embodiments, the released gas components can be off-loaded into a container. In some embodiments, the released gas components can be pumped downhole for long-term storage. In some embodiments, the released gas components can be vented to the atmosphere. In some embodiments, the released gas components include, without limitation, CO₂, H₂S, SO₂, and combinations thereof.

Reuse of the Porous Carbon Material

In some embodiments, the methods of the present disclosure also include a step of reusing the porous carbon materials after gas component release to capture more gas components from an environment. In some embodiments, the porous carbon materials of the present disclosure may be reused over 100 times without substantially affecting their gas sorption capacities. In some embodiments, the porous carbon materials of the present disclosure may be reused over 1000 times without substantially affecting their gas sorption capacities. In some embodiments, the porous carbon materials of the present disclosure may be reused over 10,000 times without substantially affecting their gas sorption capacities.

In some embodiments, the porous carbon materials of the present disclosure may retain 100 wt % of their CO₂ or H₂S sorption capacities after being used multiple times (e.g., 100 times, 1,000 times or 10,000 times). In some embodiments, the porous carbon materials of the present disclosure may retain at least 98 wt % of their CO₂ or H₂S sorption capacities after being used multiple times (e.g., 100 times, 1,000 times or 10,000 times). In some embodiments, the porous carbon materials of the present disclosure may retain at least 95 wt % of their CO₂ or H₂S sorption capacities after being used multiple times (e.g., 100 times, 1,000 times or 10,000 times). In some embodiments, the porous carbon materials of the present disclosure may retain at least 90 wt % of their CO₂ or H₂S sorption capacities after being used multiple times (e.g., 100 times, 1,000 times or 10,000 times). In some embodiments, the porous carbon materials of the present disclosure may retain at least 80 wt % of their CO₂ or H₂S sorption capacities after being used multiple times (e.g., 100 times, 1,000 times or 10,000 times).

Porous Carbon Materials

Various porous carbon materials may be utilized to capture gas from an environment. In some embodiments, the present disclosure pertains to the porous carbon materials that are utilized to capture gas from an environment.

Carbon Sources

The porous carbon materials of the present disclosure may be derived from various carbon sources. For instance, in some embodiments, the porous carbon material includes, without limitation, protein-derived porous carbon materials, carbohydrate-derived porous carbon materials, cotton-derived porous carbon materials, fat-derived porous carbon materials, waste-derived porous carbon materials, asphalt-derived porous carbon materials, coal-derived porous carbon materials, coke-derived porous carbon materials, asphaltene-derived porous carbon materials, oil product-derived porous carbon materials, bitumen-derived porous carbon materials, tar-derived porous carbon materials, pitch-derived porous carbon materials, anthracite-derived porous carbon materials, melamine-derived porous carbon materials, and combinations thereof.

In some embodiments, the porous carbon materials of the present disclosure include asphalt-derived porous carbon materials. In some embodiments, the porous carbon materials of the present disclosure include coal-derived porous carbon materials. In some embodiments, the coal source includes, without limitation, bituminous coal, anthracitic coal, brown coal, and combinations thereof.

In some embodiments, the porous carbon materials of the present disclosure include protein-derived porous carbon materials. In some embodiments, the protein source includes, without limitation, whey protein, rice protein, animal protein, plant protein, and combinations thereof.

In some embodiments, the porous carbon materials of the present disclosure include oil product-derived porous carbon materials. In some embodiments, the oil products include, without limitation, petroleum oil, plant oil, and combinations thereof.

In some embodiments, the porous carbon materials of the present disclosure include waste derived porous carbon materials. In some embodiments, the waste can include, without limitation, human waste, animal waste, waste derived from municipality sources, and combinations thereof.

The porous carbon materials of the present disclosure may also be in various states. For instance, in some embodiments, the porous carbon material is carbonized. In some embodiments, the porous carbon material is reduced. In some embodiments, the porous carbon material is vulcanized.

Nucleophilic Moieties

In some embodiments, the porous carbon materials of the present disclosure include a plurality of nucleophilic moieties. In some embodiments, the porous carbon materials of the present disclosure may contain various arrangements of nucleophilic moieties. In some embodiments, the nucleophilic moieties are part of the porous carbon material. In some embodiments, the nucleophilic moieties are embedded within the porous carbon materials. In some embodiments, the nucleophilic moieties are homogenously distributed throughout the porous carbon material framework. In some embodiments, the nucleophilic moieties are embedded within the plurality of the pores of the porous carbon materials.

In some embodiments, the nucleophilic moieties include, without limitation, primary nucleophiles, secondary nucleophiles, tertiary nucleophiles and combinations thereof. In some embodiments, the nucleophilic moieties include, without limitation, oxygen-containing moieties, sulfur-containing moieties, metal-containing moieties, metal oxide-containing moieties, metal sulfide-containing moieties, nitrogen-containing moieties, phosphorous-containing moieties, and combinations thereof.

In more specific embodiments, the nucleophilic moieties include phosphorous-containing moieties. In some embodiments, the phosphorous containing moieties include, without limitation, phosphines, phosphites, phosphine oxides, and combinations thereof.

In some embodiments, the nucleophilic moieties include nitrogen-containing moieties. In some embodiments, the nitrogen-containing moieties include, without limitation, primary amines, secondary amines, tertiary amines, nitrogen oxides, pyridinic nitrogens, pyrrolic nitrogens, graphitic nitrogens, and combinations thereof. In more specific embodiments, the nitrogen containing moieties include nitrogen oxides, such as N-oxides.

In some embodiments, the nitrogen-containing moieties include from about 1 wt % to about 15 wt % by weight of the porous carbon material. In some embodiments, the nitrogen-containing moieties include from about 2 wt % to about 11 wt % by weight of the porous carbon material. In some embodiments, the nitrogen-containing moieties include from about 5 wt % to about 9 wt % by weight of the porous carbon material. In some embodiments, the nitrogen-containing moieties include from about 8 wt % to about 11 wt % by weight of the porous carbon material. In some embodiments, the nitrogen-containing moieties include about 9 wt % by weight of the porous carbon material.

In some embodiments, the nucleophilic moieties include sulfur-containing moieties. In some embodiments, the sulfur-containing moieties include, without limitation, primary sulfurs, secondary sulfurs, sulfur oxides, and combinations thereof.

In some embodiments, the nucleophilic moieties include nitrogen-containing moieties and sulfur-containing moieties. In some embodiments, the nitrogen-containing moieties and sulfur-containing moieties induce CO₂ capture by poly(CO₂) formation. In some embodiments, the nitrogen-containing moieties induce H₂S capture by facilitating oxidation of H₂S.

Surface Areas

The porous carbon materials of the present disclosure may have various surface areas. For instance, in some embodiments, the porous carbon materials of the present disclosure have surface areas that range from about 1,000 m²/g to about 3,000 m²/g. In some embodiments, the porous carbon materials of the present disclosure have surface areas that range from about 2,500 m²/g to about 3,000 m²/g. In some embodiments, the porous carbon materials of the present disclosure have surface areas that range from about 2,500 m²/g to about 2,900 m²/g. In more specific embodiments, the porous carbon materials of the present disclosure have surface areas that include at least one of 2,200 m² g⁻¹, 2,300 m²/g, 2,600 m²/g, 2,800 m²/g, or 2,900 m² g⁻¹.

Porosities

In some embodiments, the porous carbon materials of the present disclosure include a plurality of pores. In addition, the porous carbon materials of the present disclosure may have various porosities. For instance, in some embodiments, the pores in the porous carbon materials include diameters between about 1 nanometer to about 5 micrometers. In some embodiments, the pores include macropores with diameters of at least about 50 nm. In some embodiments, the pores include macropores with diameters between about 50 nanometers to about 3 micrometers. In some embodiments, the pores include macropores with diameters between about 500 nanometers to about 2 micrometers. In some embodiments, the pores include mesopores with diameters of less than about 50 nm. In some embodiments, the pores include micropores with diameters of less than about 2 nm.

In some embodiments, the pores include diameters that range from about 1 nm to about 10 nm. In some embodiments, the pores include diameters that range from about 1 nm to about 3 nm. In some embodiments, the pores include diameters that range from about 5 nm to about 100 nm.

In some embodiments, the porous carbon materials have a uniform distribution of pore sizes. In some embodiments, the uniform pore sizes are about 1.3 nm in diameter.

The pores of the porous carbon materials of the present disclosure may also have various volumes. For instance, in some embodiments, the pores in the porous carbon materials have volumes ranging from about 1 cm³/g to about 10 cm³/g. In some embodiments, the pores in the porous carbon materials have volumes ranging from about 1 cm³/g to about 3 cm³/g. In some embodiments, the pores in the porous carbon materials have volumes ranging from about 1 cm³/g to about 1.5 cm³/g. In more specific embodiments, the plurality of pores in the porous carbon materials have volumes of about 1.1 cm³/g, about 1.2 cm³/g, or about 1.4 cm³/g.

Densities

The porous carbon materials of the present disclosure may also have various densities. For instance, in some embodiments, the porous carbon materials of the present disclosure have densities that range from about 0.3 g/cm³ to about 10 g/cm³. In some embodiments, the porous carbon materials of the present disclosure have densities that range from about 0.3 g/cm³ to about 4 g/cm³. In some embodiments, the porous carbon materials of the present disclosure have densities that range from about 1 g/cm³ to about 3 g/cm³. In some embodiments, the porous carbon materials of the present disclosure have densities that range from about 1 g/cm³ to about 2.5 g/cm³. In some embodiments, the porous carbon materials of the present disclosure have densities that range from about 2 g/cm³ to about 3 g/cm³. In more specific embodiments, the porous carbon materials of the present disclosure have densities of 1.8 g/cm³, 2 g/cm³, or 2.2 g/cm³.

CO₂ Sorption Capacities

The porous carbon materials of the present disclosure may also have various sorption capacities. For instance, in some embodiments, the porous carbon materials of the present disclosure have a CO₂ sorption capacity that ranges from about 10 wt % to about 200 wt % of the porous carbon material weight. In some embodiments, the porous carbon materials of the present disclosure have a CO₂ sorption capacity of about 50 wt % to about 200 wt % of the porous carbon material weight. In some embodiments, the porous carbon materials of the present disclosure have a CO₂ sorption capacity of about 50 wt % to about 100 wt % of the porous carbon material weight. In some embodiments, the porous carbon materials of the present disclosure have a CO₂ sorption capacity of about 100 wt % to about 200 wt % of the porous carbon material weight. In more specific embodiments, the porous carbon materials of the present disclosure have a CO₂ sorption capacity of about 120 wt % to about 130 wt % of the porous carbon material weight.

In further embodiments, the porous carbon materials of the present disclosure have a CO₂ sorption capacity of about 0.5 g to about 2 g of CO₂ per 1 g of porous carbon material. In some embodiments, the porous carbon materials of the present disclosure have a CO₂ sorption capacity of about 1 g to about 2 g of CO₂ per 1 g of porous carbon material. In some embodiments, the porous carbon materials of the present disclosure have a CO₂ sorption capacity of about 1.2 g to about 1.3 g of CO₂ per 1 g of porous carbon material.

In further embodiments, the porous carbon materials of the present disclosure have a CO₂ sorption capacity of about 0.6 g to about 2.0 g of CO₂ per 1 g of porous carbon material. In some embodiments, the porous carbon materials of the present disclosure have a CO₂ sorption capacity of about 1 g to about 1.2 g of CO₂ per 1 g of porous carbon material. In some embodiments, the porous carbon materials of the present disclosure have a CO₂ sorption capacity of about 1.2 g of CO₂ per 1 g of porous carbon material.

H₂S Sorption Capacities

The porous carbon materials of the present disclosure may also have various H₂S sorption capacities. For instance, in some embodiments, the porous carbon materials of the present disclosure have a H₂S sorption capacity that ranges from about 10 wt % to about 300 wt % of the porous carbon material weight. In some embodiments, the porous carbon materials of the present disclosure have a H₂S sorption capacity of about 50 wt % to about 300 wt % of the porous carbon material weight. In some embodiments, the porous carbon materials of the present disclosure have a H₂S sorption capacity of about 50 wt % to about 250 wt % of the porous carbon material weight. In some embodiments, the porous carbon materials of the present disclosure have a H₂S sorption capacity of about 100 wt % to about 250 wt % of the porous carbon material weight. In more specific embodiments, the porous carbon materials of the present disclosure have a H₂S sorption capacity of about 100 wt % to about 150 wt % of the porous carbon material weight.

In further embodiments, the porous carbon materials of the present disclosure have a H₂S sorption capacity of about 0.5 g to about 3 g of sulfur from H₂S per 1 g of porous carbon material. In some embodiments, the porous carbon materials of the present disclosure have a H₂S sorption capacity of about 0.5 g to about 2.5 g of sulfur from H₂S per 1 g of porous carbon material. In some embodiments, the porous carbon materials of the present disclosure have a H₂S sorption capacity of about 1 g to about 2.5 g of sulfur from H₂S per 1 g of porous carbon material. In some embodiments, the porous carbon materials of the present disclosure have a H₂S sorption capacity of about 1 g to about 1.5 g of sulfur from H₂S per 1 g of porous carbon material.

Physical States

The porous carbon materials of the present disclosure may be in various states. For instance, in some embodiments, the porous carbon materials of the present disclosure may be in a solid state. In some embodiments, the porous carbon materials of the present disclosure may be in a gaseous state. In some embodiments, the porous carbon materials of the present disclosure may be in a liquid state.

Methods of Forming Porous Carbon Materials

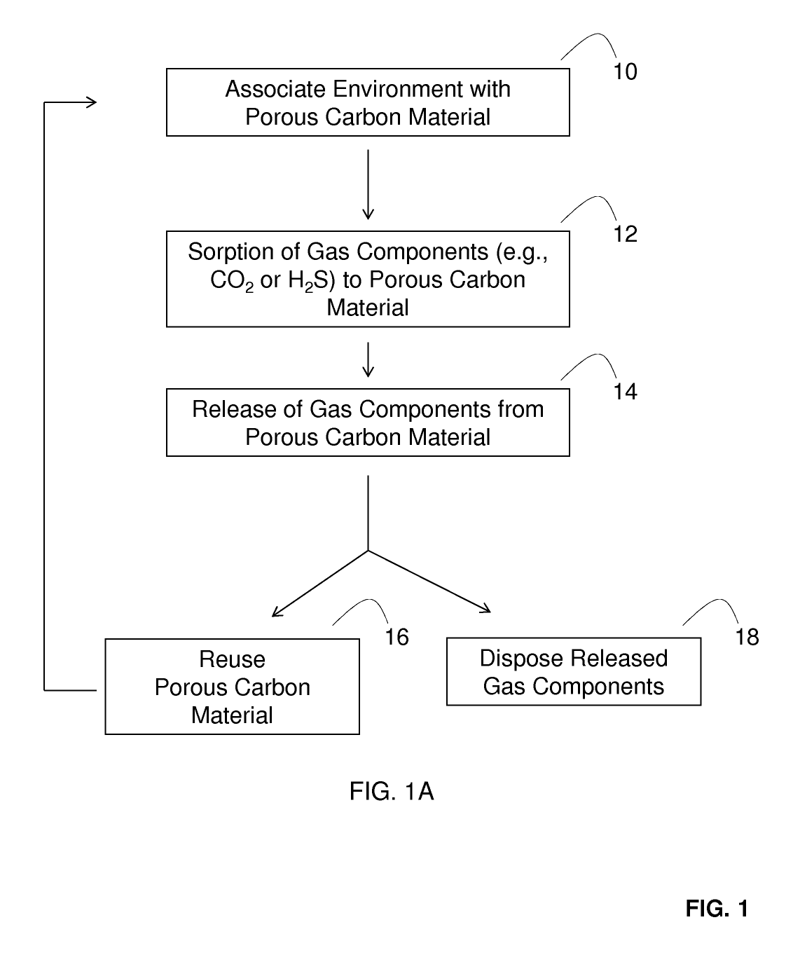

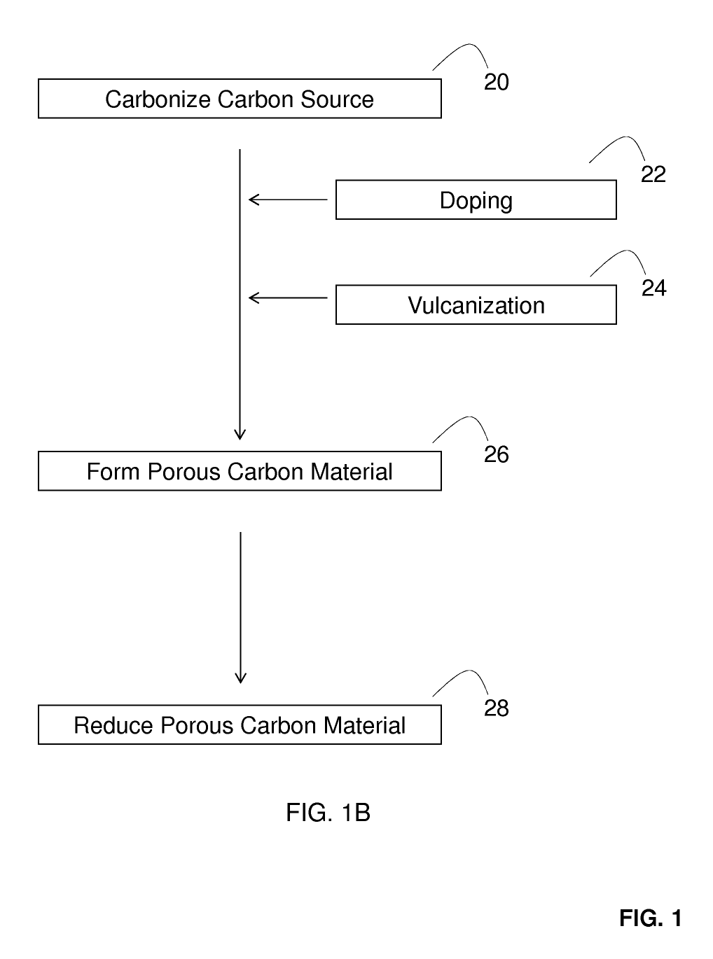

In some embodiments, the present disclosure pertains to methods of forming the porous carbon materials of the present disclosure. In some embodiments that are illustrated in FIG. 1B, such methods include carbonizing a carbon source (step 20) to form porous carbon materials (step 26). In some embodiments, the methods of the present disclosure also include a step of doping the carbon source (step 22). In some embodiments, the methods of the present disclosure also include a step of vulcanizing the carbon source (step 24). In some embodiments, the methods of the present disclosure also include a step of reducing the formed porous carbon material (step 28).

As set forth in more detail herein, various methods may be utilized to carbonize various types of carbon sources. In addition, various methods may be utilized to dope and vulcanize the carbon sources. Likewise, various methods may be utilized to reduce the formed porous carbon materials.

Carbon Sources

Various carbon sources may be utilized to form porous carbon materials. In some embodiments, the carbon sources include, without limitation, protein, carbohydrates, cotton, fat, waste, asphalt, coal, coke, asphaltene, oil products, bitumen, tar, pitch, anthracite, melamine, and combinations thereof.

In some embodiments, the carbon source includes asphalt. In some embodiments, the carbon source includes coal. In some embodiments, the coal source includes, without limitation, bituminous coal, anthracitic coal, brown coal, and combinations thereof. In some embodiments, the carbon source includes protein. In some embodiments, the protein source includes, without limitation, whey protein, rice protein, animal protein, plant protein, and combinations thereof.

In some embodiments, the carbon source includes oil products. In some embodiments, the oil products include, without limitation, petroleum oil, plant oil, and combinations thereof.

Carbonizing

In the present disclosure, carbonization generally refers to processes or treatments that convert a carbon source (e.g., a non-porous carbon source) to a porous carbon material. Various methods and conditions may be utilized to carbonize carbon sources.

For instance, in some embodiments, the carbonizing occurs in the absence of a solvent. In some embodiments, the carbonizing occurs in the presence of a solvent.

In some embodiments, the carbonizing occurs by exposing the carbon source to a carbonizing agent. In some embodiments, the carbonizing agent includes metal hydroxides or metal oxides. In some embodiments, the carbonizing agent includes, without limitation, potassium hydroxide (KOH), sodium hydroxide (NaOH), lithium hydroxide (LiOH), cesium hydroxide (CsOH), magnesium hydroxide (Mg(OH)₂), calcium hydroxide (Ca(OH)₂), and combinations thereof. In some embodiments, the carbonizing agent includes potassium hydroxide (KOH). In some embodiments, the carbonizing agent can be a metal oxide. In some embodiments, the metal oxide includes, without limitation, calcium oxide (CaO), magnesium oxide (MgO), and combinations thereof. In some embodiments, the weight ratio of the carbon source to the carbonizing agent varies from about 1:1 to about 1:5. In some embodiments, the weight ratio of the carbon source to the carbonizing agent is about 1:4.

In some embodiments, the carbonizing occurs by grinding the carbon source in the presence of a carbonizing agent. In some embodiments, the grinding occurs in a mortar. In some embodiments, the grinding includes ball milling. In some embodiments, the grinding results in the formation of a homogenous solid powder.

In some embodiments, the carbon source and the carbonizing agent can be mixed in a solvent. In some embodiments, the solvent is evaporated after mixing. In some embodiments, the evaporation is followed by the carbonization of the carbon source at elevated temperature. In some embodiments, the carbon source is the solvent, and the carbonizing agent is added prior to carbonization at elevated temperatures.

In some embodiments, the carbonizing occurs by heating the carbon source at temperatures ranging from about 200° C. to about 800° C. In some embodiments, the heating occurs at temperatures greater than 500° C. In some embodiments, the heating occurs at temperatures of about 500° C. to about 800° C. In some embodiments, the heating occurs at temperatures of about 600° C. to about 700° C.

In some embodiments, the carbonizing occurs in an inert atmosphere. In some embodiments, the inert atmosphere includes a steady flow of an inert gas, such as argon.

Doping

In some embodiments, the methods of the present disclosure also include a step of doping a carbon source with a dopant. In some embodiments, the dopant includes, without limitation, nitrogen-containing dopants, sulfur-containing dopants, heteroatom-containing dopants, oxygen-containing dopants, sulfur-containing dopants, metal-containing dopants, metal oxide-containing dopants, metal sulfide-containing dopants, phosphorous-containing dopants, and combinations thereof.

In some embodiments, the dopant includes nitrogen-containing dopants. In some embodiments, the nitrogen-containing dopants include, without limitation, primary amines, secondary amines, tertiary amines, nitrogen oxides, pyridinic nitrogens, pyrrolic nitrogens, graphitic nitrogens, and combinations thereof. In some embodiments, the nitrogen-containing dopant includes NH₃.

In some embodiments, the dopant includes sulfur-containing dopants. In some embodiments, the sulfur-containing dopants include, without limitation, primary sulfurs, secondary sulfurs, sulfur oxides, and combinations thereof. In some embodiments, the sulfur-containing dopants include H₂S.

In some embodiments, the dopants include monomers, such as nitrogen-containing monomers. In some embodiments, the monomers are subsequently polymerized.

Doping can occur at various temperatures. For instance, in some embodiments, the doping occurs at temperatures ranging from about 200° C. to about 800° C. In some embodiments, the doping occurs at temperatures ranging from about 600° C. to about 700° C. In some embodiments, the doping occurs at about 650° C. to about 700° C.

Various amounts of dopants may be utilized. For instance, in some embodiments, the weight ratio of the dopant to the carbon source varies from about 0.2:1 to about 1:1. In some embodiments, the weight ratio of the dopant to the carbon source is about 1:1.

Vulcanization

In some embodiments, the methods of the present disclosure also include a step of vulcanizing the carbon source. In some embodiments, the vulcanizing includes exposing the carbon source to a vulcanizing agent. In some embodiments, the vulcanizing agent includes, without limitation, sulfur-based agents, peroxides, urethane cross-linkers, metallic oxides, acetoxysilane, and combinations thereof. In some embodiments, the vulcanizing agent includes, without limitation, tetramethyldithiuram, 2,2′-dithiobis(benzothiazole), and combinations thereof.

Various amounts of vulcanizing agents may be utilized. For instance, in some embodiments, the weight ratio of the vulcanization agent to the carbon source varies from about 5 wt % to about 200 wt % relative to the carbon source.

Reduction

In some embodiments, the methods of the present disclosure include a step of reducing the formed porous carbon material. In some embodiments, the reducing occurs by exposing the formed porous carbon material to a reducing agent. In some embodiments, the reducing agent includes, without limitation, H₂, NaBH₄, hydrazine, and combinations thereof. In some embodiments, the reducing agent includes H₂.

The methods of the present disclosure may be utilized to make bulk quantities of porous carbon materials. For instance, in some embodiments, the methods of the present disclosure can be utilized to make porous carbon materials in quantities greater than about 1 g. In some embodiments, the methods of the present disclosure can be utilized to make porous carbon materials in quantities greater than about 1 kg. In some embodiments, the methods of the present disclosure can be utilized to make porous carbon materials in quantities greater than about 1000 kg.

Advantages

The gas capture methods and the porous carbon materials of the present disclosure provide numerous advantages over prior gas sorbents. For instance, the porous carbon materials of the present disclosure provide significantly higher CO₂ and H₂S sorption capacities than prior sorbents. Moreover, due to the availability and affordability of the starting materials, the porous carbon materials of the present disclosure can be made in a facile and economical manner in bulk quantities. Furthermore, unlike traditional gas sorbents, the porous carbon materials of the present disclosure can selectively capture and release CO₂ and H₂S at ambient temperature without requiring a temperature swing. As such, the porous carbon materials of the present disclosure can avoid substantial thermal insults and be used effectively over successive cycles without losing their original CO₂ and H₂S sorption capacities.

Accordingly, the gas capture methods and the porous carbon materials of the present disclosure can find numerous applications. For instance, in some embodiments, the gas capture methods and the porous carbon materials of the present disclosure can be utilized for the capture of CO₂ and H₂S from subsurface oil and gas fields. In more specific embodiments, the process may take advantage of differential pressures commonly found in natural gas collection and processing streams as a driving force during CO₂ and H₂S capture. For instance, in some embodiments, the methods of the present disclosure may utilize a natural gas-well pressure (e.g., a natural gas well pressure of 200 to 300 bar) as a driving force during CO₂ and H₂S capture. Thereafter, by lowering the pressure back to ambient conditions after CO₂ and H₂S uptake, the captured gas can be off-loaded or pumped back downhole into the structures that had held it for geological timeframes. Moreover, the gas capture methods and the porous carbon materials of the present disclosure can allow for the capture and reinjection of CO₂ and H₂S at the natural gas sites, thereby leading to greatly reduced CO₂ and H₂S emissions from natural gas streams.

In some embodiments, the methods of the present disclosure can be utilized for the selective release of captured CO₂ and H₂S. For instance, in some embodiments where a porous carbon material has captured both CO₂ and H₂S, the lowering of environmental pressure can result in the release of CO₂ from the porous carbon material and the retainment of the captured H₂S from the porous carbon material. Thereafter, the captured H₂S may be released from the porous carbon material by heating the porous carbon material (e.g., at temperatures between about 50° C. to about 100° C.). In additional embodiments where a porous carbon material has captured both CO₂ and H₂S, the heating of the porous carbon material (e.g., at temperatures between about 50° C. to about 100° C.) can result in the release of the captured H₂S and the retainment of the captured CO₂. Thereafter, the lowering of environmental pressure can result in the release of CO₂ from the porous carbon.

Reference will now be made to more specific embodiments of the present disclosure and experimental results that provide support for such embodiments. However, Applicants note that the disclosure below is for illustrative purposes only and is not intended to limit the scope of the claimed subject matter in any way.

### Example 1

### Asphalt-Derived Porous Carbons for CO₂ Capture

In this Example, Applicants report the preparation and CO₂ uptake capacity of microporous carbon materials synthesized from asphalt. Carbonization of asphalt with potassium hydroxide (KOH) at high temperatures (>873 K) yields asphalt-derived porous carbons (A-PC) with Brunauer-Emmett-Teller (BET) surface areas of up to 2800 m²g⁻¹ and CO₂ uptake capacities of up to 25 mmol/g at 30 bar and 298 K. Further nitrogen doping of the A-PCs yields active N-doped A-PCs (also referred to as A-NPCs) containing up to 9.3 wt % nitrogen. The A-NPCs have enhanced BET surface areas of up to 2900 m²g⁻¹ and CO₂ uptake capacities of up to 1.2 g at 30 bar and 298 K. To the best of Applicants' knowledge, such results represent the highest reported CO₂ uptake capacities among the family of activated porous carbon materials. Thus, the porous carbon materials derived from asphalt demonstrate the required properties for capturing CO₂ at a well-head during the extraction of natural gas under high pressure.

### Example 1.1

### Synthesis and Characterization of Asphalt-Derived Porous Carbon Materials

Asphalt-derived porous carbons (A-PCs) were prepared by carbonization of a molded mixture of asphalt and potassium hydroxide (KOH) at higher temperatures under inert atmosphere (Ar). The treatment of asphalt with KOH was conducted at various temperatures (200° C.-800° C.) and asphalt/KOH weight ratios (varied from 1/1 to 1/5). In addition, the reaction conditions were adjusted and tuned by the CO₂ uptake performance of the final porous carbon materials.

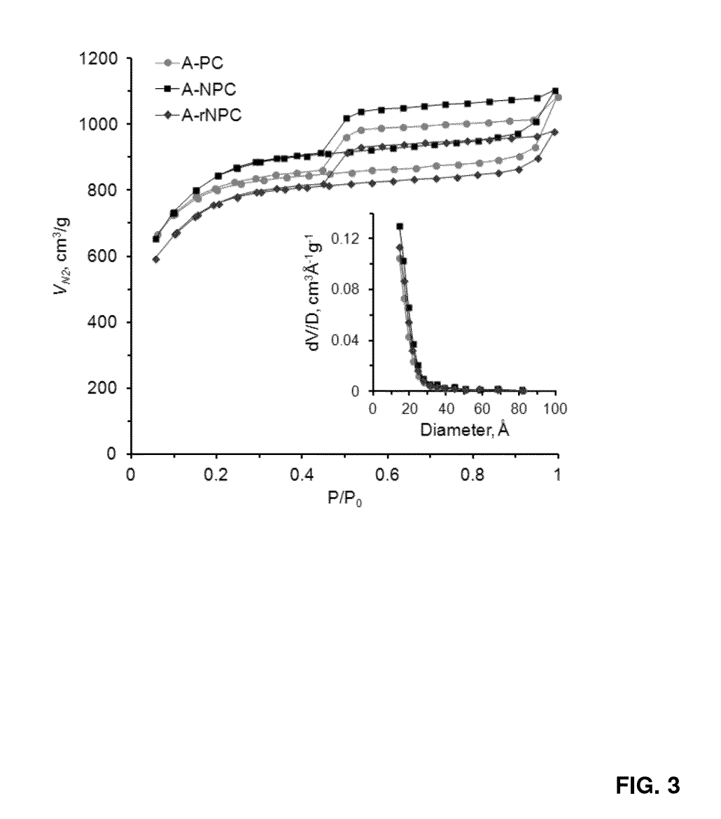

In a more specific example, A-PC was synthesized at 700° C. at an asphalt:KOH weight ratio of 1:4. As shown in FIG. 3, the produced A-PC has a steep nitrogen uptake at low pressures (0-0.3 P/Pₒ), indicative of the large amount of microporous structures with uniform distribution of pore sizes ˜1.3 nm (see FIG. 3 inset). The BET surface area (2779 m²/g) and the pore volume (1.17 cm³/g) were calculated from the nitrogen isotherms (see Table 1). X-ray photoelectron spectroscopy (XPS) of the A-PC showed C 1s and O 1s signals with ˜10 wt % of oxygen content, which are assigned to C—O and C═O functional groups (data not shown).

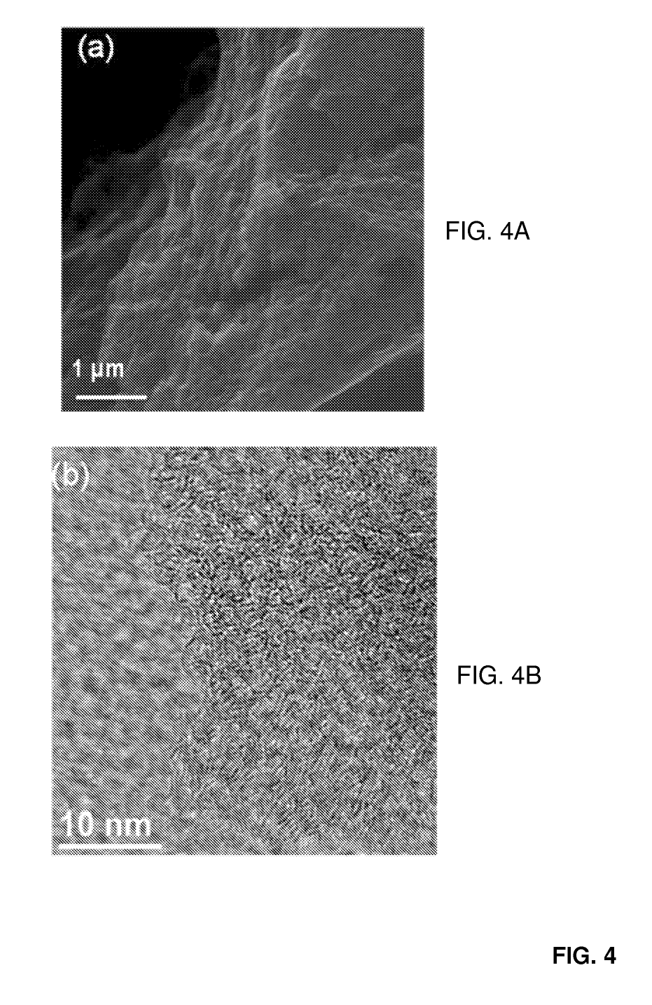

Scanning electron microscopy (SEM) images of the A-PCs show porous materials with uniform distribution of the micropores (FIG. 4A). Uniform distribution of the micropores are further indicated by the transmission electron microscopy (TEM) images (FIG. 4B) that show pore diameters of about 1.5 nm, which is very close to the number extracted from nitrogen absorption isotherms.

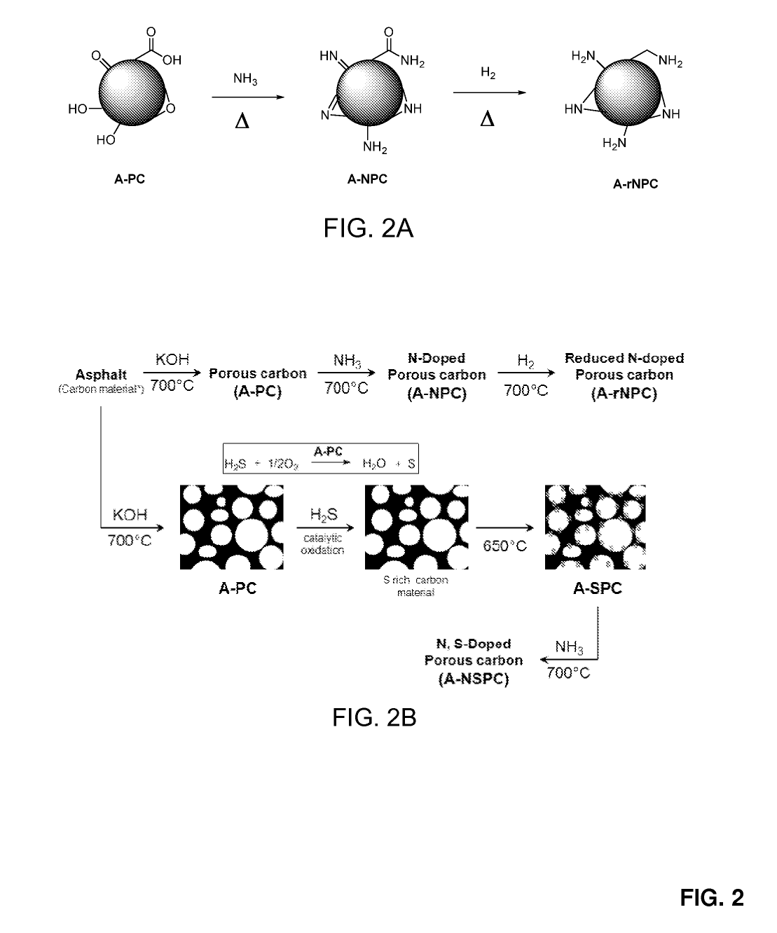

Treatment of A-PCs with NH₃ at elevated temperatures resulted in N-doped porous carbon materials (A-NPC) (FIG. 2A). The nitrogen content and the surface area increased considerably after treatment of A-PCs with NH₃ at higher temperatures, as shown in Tables 1 and 2. This leads to the formation of A-NPCs with a nitrogen concentration of up to 9.3 wt %.

TABLE 1
Properties and CO₂ uptake capacities of various porous carbons.

| | | Pore | | CO₂ uptake |
|---|---|---|---|---|
| | S_{BET} | volume | Density | capacity at 30 bar |
| Samples | (m²/g)^{a} | (cm³/g)^{a} | (g/cm³) | (g/g)^{b} |
| A-PC | 2779 | 1.17 | 2 | 0.96 |
| A-NPC | 2858 | 1.20 | 2 | 1.10 |
| A-rNPC | 2583 | 1.09 | 2 | 1.19 |
| SPC | 2500 | 1.01 | 2.21 | 0.74 |
| NPC | 1490 | 1.40 | 1.8 | 0.60 |
| rNPC | 1450 | 1.43 | 1.8 | 0.67 |

^{a}Estimated from N₂ absorption isotherms at 77 K, where samples were dried at 200° C. for 20 h prior to the measurements.
^{b}CO₂ uptake capacity at 23° C.

TABLE 2
Elemental composition and CO₂ uptake capacities
of activated porous carbons.

| | | | | | | | CO₂ |
|---|---|---|---|---|---|---|---|
| | XPS | | | | | | uptake |
| | | | | Pyri- | Pyr- | Gra- | capacity |
| | | | | dinic | rolic | phitic | at 30 bar |
| Samples | C % | O % | N % | N % | N % | N % | (g/g)^{a} |
| A-NPC(500) | 91.1 | 6.1 | 2.7 | 29.7 | 63.3 | 7.0 | 1.02 |
| A-NPC(600) | 90.6 | 6.4 | 3.0 | 33.1 | 52.6 | 14.3 | 1.04 |
| A-NPC(700) | 91.1 | 4.2 | 4.7 | 53.2 | 41.4 | 5.4 | 1.06 |
| A-NPC(800) | 81.0 | 9.7 | 9.3 | 52.3 | 45.4 | 2.3 | 0.93 |
| A-rNPC | 88.0 | 7.5 | 4.5 | 55.1 | 40.3 | 4.6 | 1.19 |

^{a}CO₂ uptake capacity at 23° C.

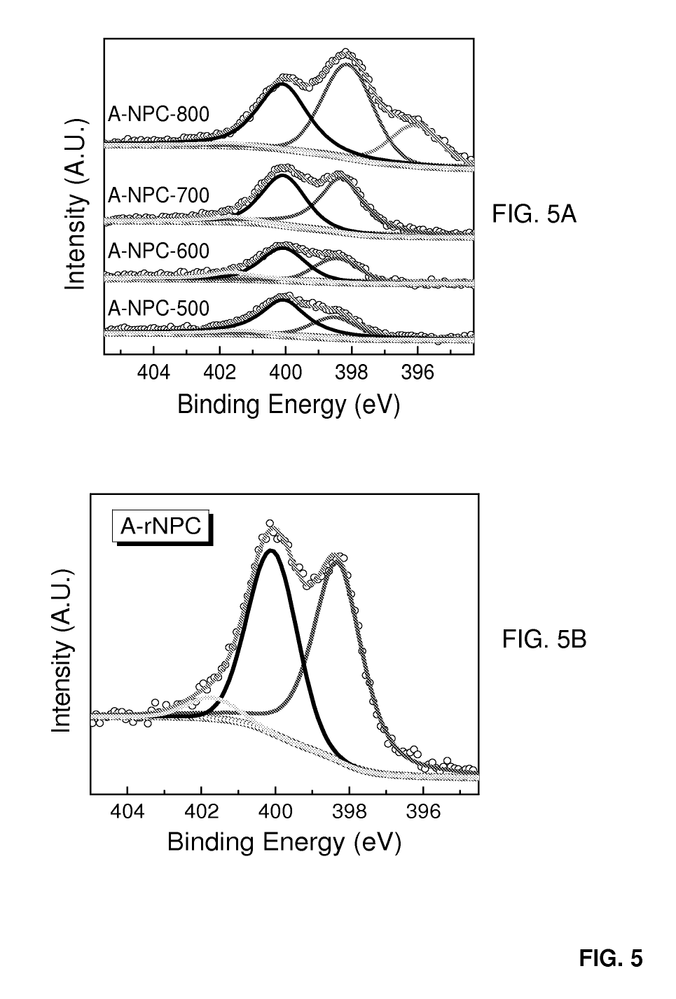

The surface N-bonding configurations reveal three main nitrogen functional groups in the surface of the carbon framework. As shown in FIG. 5A, the N 1s spectra at variable doping temperatures deconvoluted into three peaks with binding energies of about 399, 400.7±4, and about 401.7. These binding energies are in the range of typical binding energies corresponding to pyridinic N, pyrollic N and graphitic N, respectively. The new peak at the binding energy of about 396 was observed at 800° C., which was assigned to the N—Si binding energy. Without being bound by theory, it is envisioned that, at high pyrolysis temperatures, NH₃-doping of silica from the quartz reaction tube starts to interfere with the doping process.

Further H₂ treatment of A-NPCs at 700° C. resulted in formation of reduced A-NPCs (A-rNPC). The elemental composition and the surface area of the A-rNPCs were investigated using XPS (see FIG. 5B and Table 2). The XPS spectrum of the produced A-rNPCs (FIG. 5B) is similar to the XPS spectrum of A-NPCs (FIG. 5A). A schematic representation of the synthetic route for the production of A-rNPCs is shown in FIG. 2A.

Applicants also observed that, as reaction temperatures increased, the relative trend of the pyrrolic nitrogens in A-NPCs increased. However, the opposite was observed for pyridinic nitrogens. These results indicate that pyrolysis temperature during NH₃ treatment plays a significant factor in determining the CO₂ uptake performance of A-NPCs.

### Example 1.2

### CO₂ Uptake Capacity of the Asphalt Derived Porous Carbon Materials

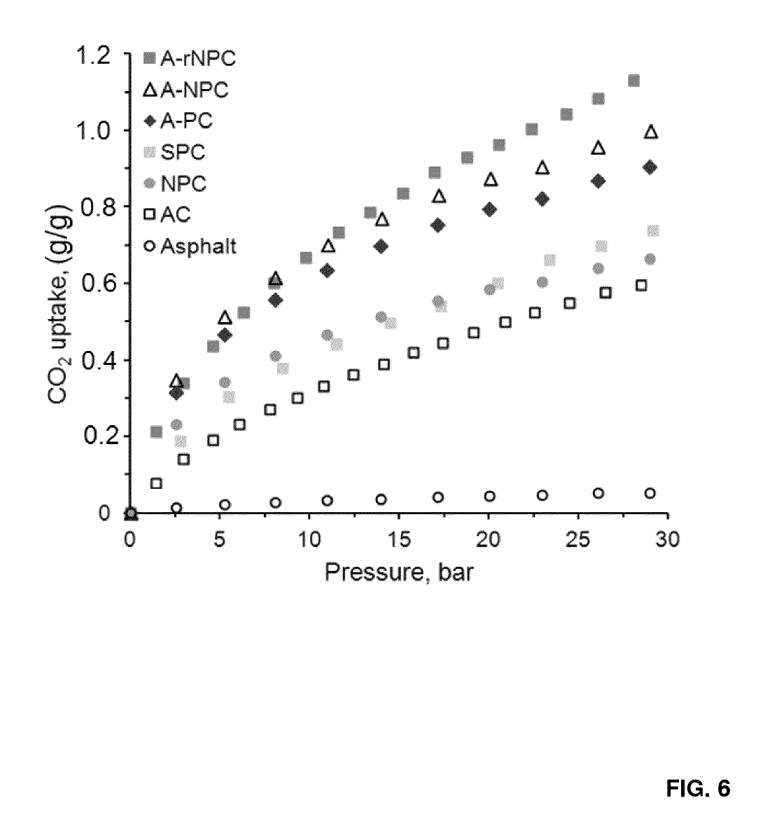

The CO₂ uptake capacities of A-PC, A-NPC, and A-rNPC were compared to the CO₂ uptake capacities of prior porous carbon materials, including nitrogen containing nucleophilic porous carbons derived from poly(acrylonitrile) (NPCs), sulfur containing porous carbons derived from poly[(2-hydroxymethyl)thiophene (SPCs), commercial activated carbon, and asphalt (the NPCs and SPCs were described previously in PCT/US2014/044315 and Nat Commun., 2014 June 3, 5:3961, doi: 10.1038/ncomms4961). The CO₂ uptake capacities were measured by a volumetric method at room temperature over the pressure range of 0-30 bar. The results are shown in FIG. 6.

Applicants also observed that volumetric CO₂ uptake by A-PC, A-NPC and A-rNPC do not show any hysteresis (data not shown). Such observations suggest that the asphalt-derived porous carbon materials uptake CO₂ in a reversible manner. The CO₂ uptake capacities at a pressure of 30 bar are summarized in Tables 1 and 2. Such CO₂ uptake capacities (i.e., up to 30 mmol/g) are the highest reported CO₂ uptake capacities among the activated carbons. Such CO₂ uptake capacities are also comparable to the highest CO₂ uptake capacities of synthetic metal-organic frameworks (MOFs).

A-rNPC has the highest CO₂ uptake performance at 30 bar, although the highest surface is obtained for A-NPC. As Applicants increased the N-doping temperature (from 500° to 800° C.), pyrollic nitrogen starts to decrease in intensity, which is linearly proportional to the CO₂ uptake performance of the A-NPCs (see Table 2). Thus, without being bound by theory, Applicants envision that pyrrolic nitrogens play a more significant role in CO₂ uptake performance than the bulk nitrogen content of the porous carbon material.

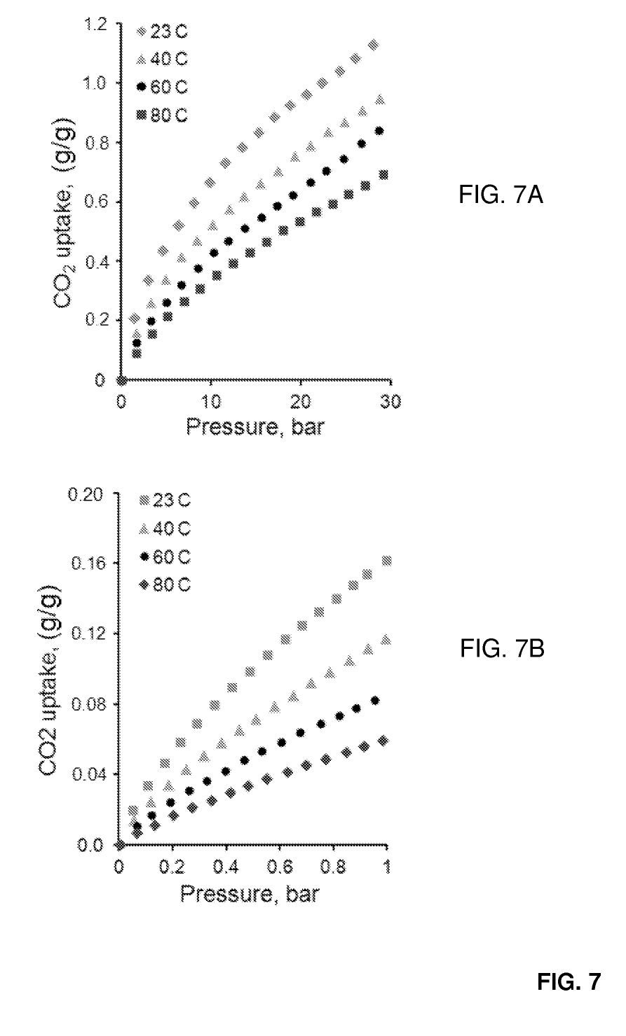

FIG. 7 shows the high and low pressure CO₂ uptake capacity of A-rNPC as temperature increases. As in other solid physisorbents such as activated carbons, zeolites and MOFs, the CO₂ uptake capacity decreases with increasing temperature. However, when compared with commercial activated carbon and SPC, the decrease in CO₂ uptake at higher temperature is lower. This suggests the higher and uniform microporosity of A-rNPCs, or the efficacy of poly(CO₂) formation.

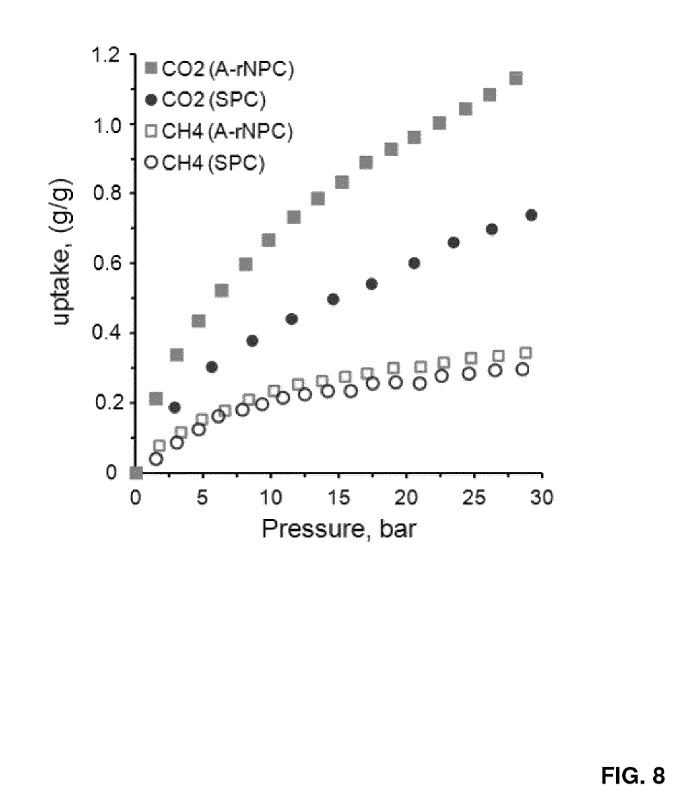

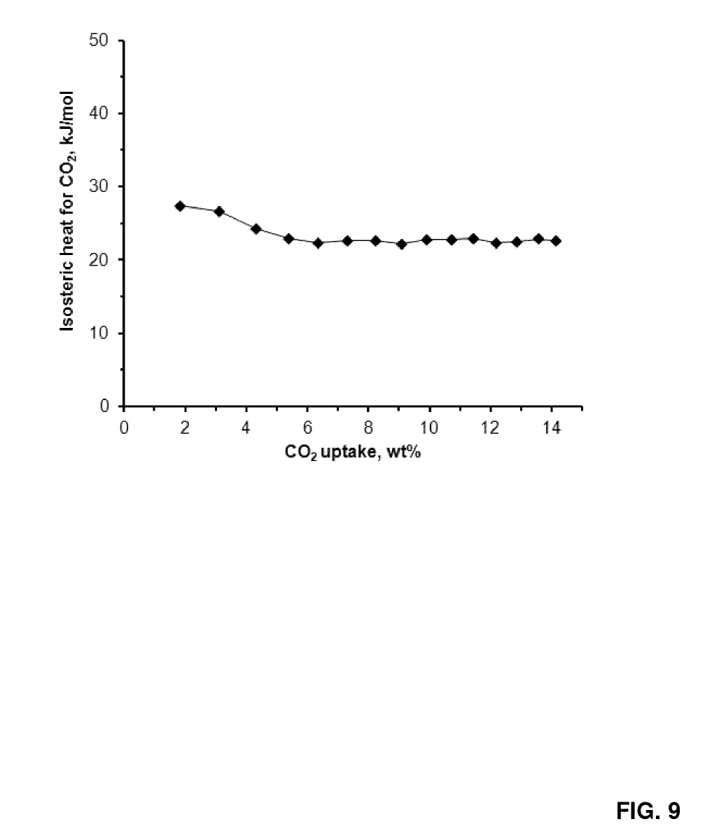

Another key property of the activated carbon materials is the CO₂/CH₄ selectivity. In order to evaluate the CO₂/CH₄ selectivity of A-PC, A-NPC and A-rNPCs, Applicants compared CH₄ uptake performances with SPC, activated carbon, and ZIF-8 sorbents over the 0-30 bar pressure range at 23° C. FIG. 8 shows the comparison of the CO₂ and CH₄ sorption capacities of A-rNPC and SPC. A-rNPCs have higher CH₄ (8.6 mmol/g) uptake relative to SPC (7.7 mmol·g) at 30 bar, which is in agreement with the higher surface area for A-rNPC (2583 m²/g) than the SPC (2500 m²/g).

The molar ratios of sorbed CO₂ and CH₄ (ν_{CO2}/ν_{CH4}) were estimated as the ratios of the amount of absorbed gases at 30 bar. The measured ν_{CO2}/ν_{CH4} for A-rNPC was found to be about 3.5. This value was compared to values for SPC (2.6), activated carbon (1.5) and ZIF-8 (1.9).

In addition, the isosteric heat of absorption of CO₂ and CH₄ on the surfaces of A-PC, A-NPC and A-rNPC were calculated using low pressure CO₂ sorption isotherms at 23° C. and 80° C. The measured value was found to be about 27 kJ/mol.

### Example 2

### Asphalt-Derived Porous Carbons for CO₂ and H₂S Capture

This Example pertains to the further production and characterization of A-NPCs, A-SPCs, A-rNPCs, and A-NSPCs. In addition, this Example pertains to the use of the aforementioned carbon materials for the capture of both CO₂ and H₂S.

### Example 2.1

### Synthesis and Characterization of Asphalt-Derived Porous Carbon Materials

Asphalt carbon sources were ground with KOH in a mortar. The weight ratio of KOH to the asphalt carbon source was from about 1:3 to about 1:4. The homogeneous powder was heated at 500-800° C. under Ar atmosphere for 1 hour. This was followed by filtration and washing with 10 wt % HCl_{(aq)} and copious amounts of DI water until the extracts were neutral. The filtered sample was then dried at 110° C. until a constant weight was obtained. The above steps produced A-PC.

A-NPC was prepared by annealing the A-PC at 700° C. for 1 hour under an NH₃-containing atmosphere. A-rNPC was prepared by further reduction of A-NPC with 10 wt % H₂ at 700° C. for 1 hour. A-SPC was prepared by exposing the A-PC to a sulfur source and annealing the sulfur impregnated A-PC at 650° C. for 1 hour. A-NSPC was prepared by annealing the produced A-SPC for 1 hour under an NH₃-containing atmosphere to yield A-NSPC.

Next, the produced porous carbon materials were characterized and tested for uptake of CO₂ and H₂S. The results are summarized in Table 3.

TABLE 3
The properties and gas uptake capacities of various asphalt-
derived porous carbon materials. Asphalt-Versatrol HT Gilstonite,
a naturally occurring asphalt from MI SWACO, was used as a control.
The H₂S uptake capacities of the porous carbon materials
were measured as a function of the amount of sulfur retained
on the porous carbon material.

| | | | | | | | CO₂ |
|---|---|---|---|---|---|---|---|
| | Textural | | | | | H₂S | Uptake |
| | Properties | Chemical Composition | | | | Uptake | Capacity |
| | SBET | (atomic %) | | | | Capacity | at 30 bar |
| Sample | (m2/g) | N | C | O | S | (g/g) | (g/g) |
| Asphalt* | 0.6 | — | — | — | — | — | 0.05 |
| A-PC | 2,613 | 0.5 | 91.4 | 8.1 | — | 1.06 | 0.92 |
| A-NPC | 2,300 | 5.7 | 91.0 | 3.3 | — | 1.50 | 1.01 |
| A-rNPC | 2,200 | 3.6 | 92.7 | 3.7 | — | 2.05 | 1.12 |
| A-SPC | 2,497 | — | 90.3 | 7.1 | 2.7 | — | 1.16 |
| A-NSPC | 2,510 | 1.6 | 86.7 | 11.0 | 0.7 | — | 1.32 |

In order to characterize the H₂S uptake capacities of the porous carbon materials, the porous carbon materials were first dried at 120° C. for 1 hour under vacuum (0.05 Torr). Next, the porous carbon material was treated with H₂S under an air flow for 1 hour. The amount of sulfur retained on the porous carbon material was measured by thermogravimetric analysis (TGA).

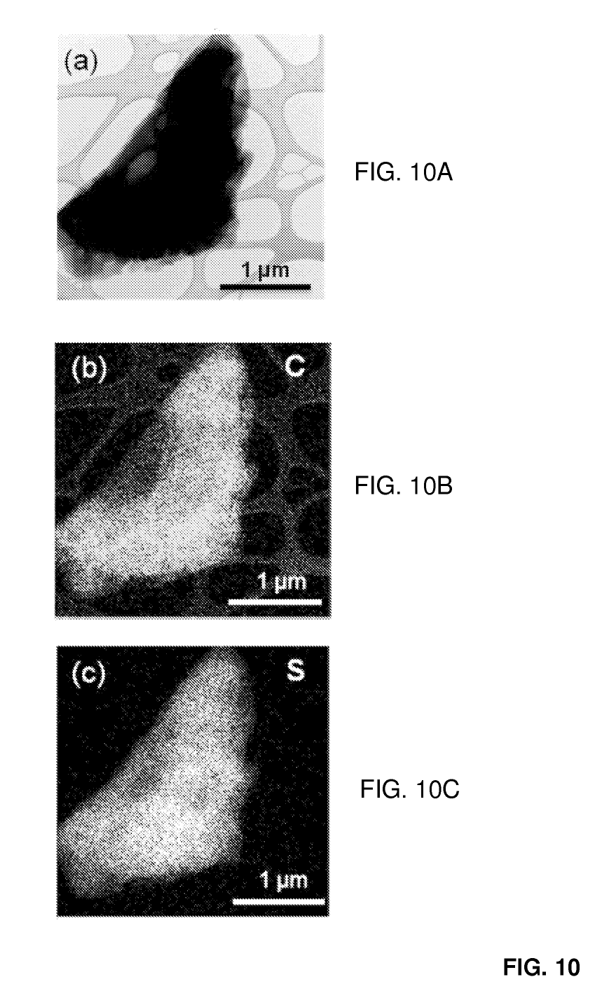

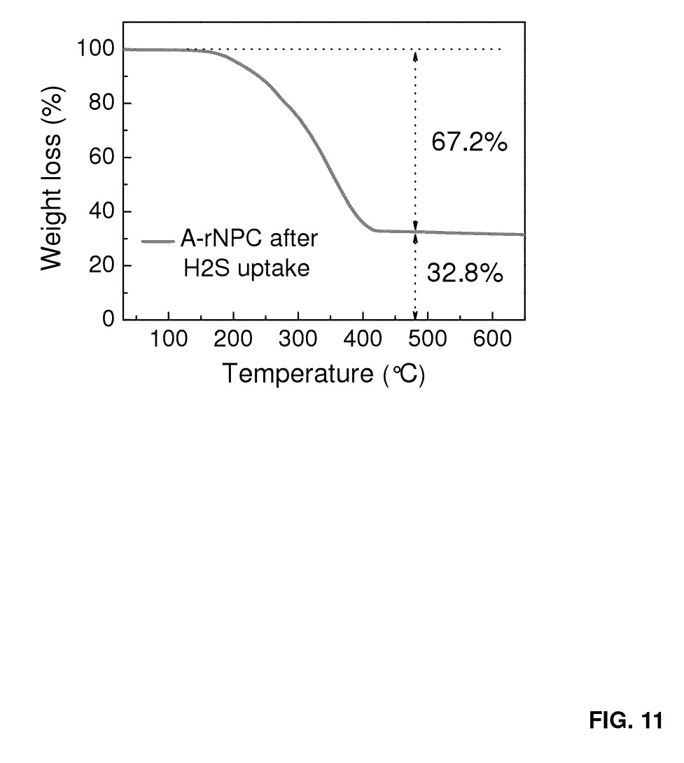

After H₂S uptake and air oxidation to S, A-rNPC was further characterized by TEM EDS elemental mapping. As shown in FIG. 10, sulfur is uniformly distributed within the pores of A-rNPCs. In addition, the TGA curve of the A-rNPCs after H₂S uptake and conversion to sulfur is shown in FIG. 11.

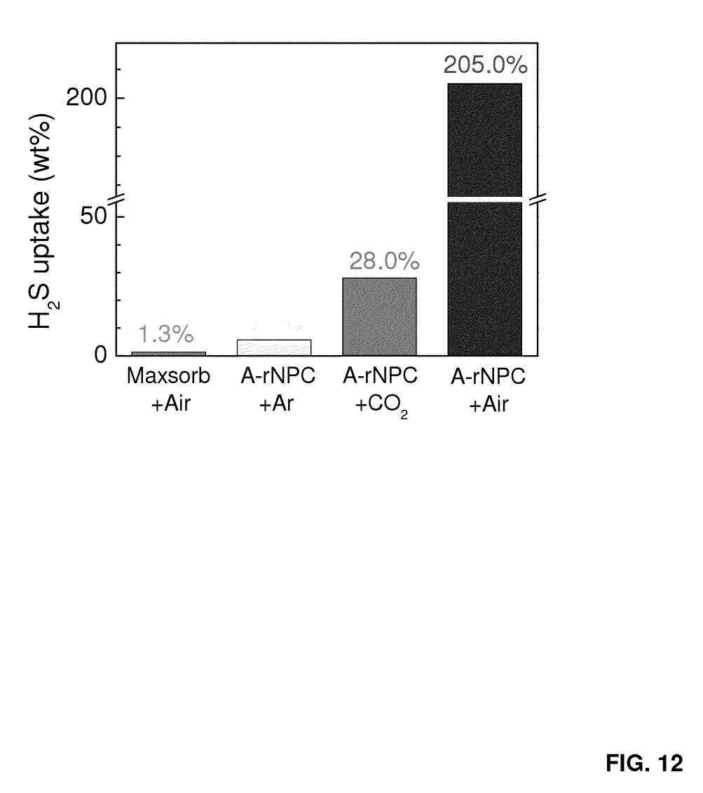

The H₂S uptake of A-rNPC was also measured under different conditions, including inert or oxidative conditions. The results are summarized in FIG. 12. The results show that A-rNPC can capture H₂S effectively in the presence of O₂ from air. When CO₂ was present, A-rNPC also showed H₂S capture behavior. The air conditions can mimic H₂S capture by porous carbon materials during natural gas flow from a wellhead, injection of a slug of air to convert the sorbed H₂S to S, and the continuation of H₂S capture from the natural gas source.

Without being bound by theory, it is envisioned that, as a result of the basic functional groups on the surface of A-NPCs and A-rNPCs, and as a result of the pH values of A-NPCs (pH=7.2) and A-rNPCs (pH=7.5), the porous carbon materials of the present disclosure can capture H₂S by an acid-base reaction, where an amine group on the porous carbon abstracts a proton from H₂S to yield the ammonium salts and hydrogen monosulfide anions according to the following scheme:

R₃N (where R is the carbon scaffold or a proton)+H₂S→R₃NH⁺ or R₂SH⁺+HS⁻

In this case, the equilibrium constant (k_{eq}) is ˜1000 based on the pKa values of the starting materials (H₂S) and products (ammonium species). As a result of the reaction of HS⁻ ions with O₂ from air introduced in the carbon support, the captured H₂S produces sulfur products such as S, SO₂ and H₂SO₄. The catalytic oxidation of H₂S on A-NPC, A-rNPC and A-PC can proceed at room temperature by air oxidation.

Applicants also observed that nitrogen doping doubles the H₂S capturing capacity of the porous carbon materials (FIGS. 11-12 and Table 3). Without being bound by theory, it is envisioned that the extent of oxidation appears to be driven by the distribution of the catalytic centers, such as nitrogen-containing basic functional groups. Additionally, Applicants observed that the oxidative capturing of H₂S by A-PCs can form sulfur-impregnated A-PCs (A-SPCs) upon heating at 650° C. (FIG. 2B).

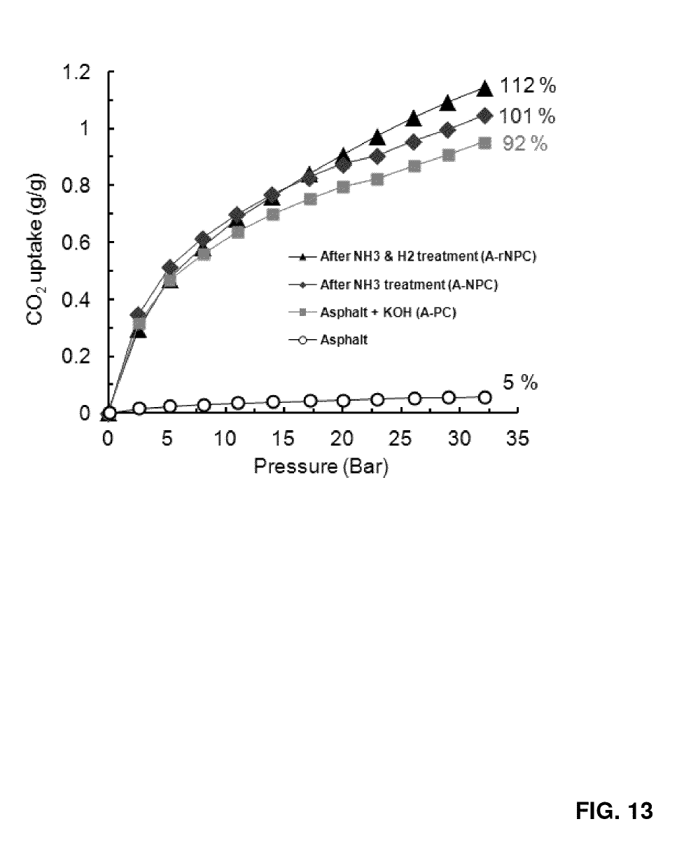

The CO₂ uptake capacities of the porous carbon materials were also evaluated. As shown in FIG. 13, the CO₂ uptake capacities of A-NPCs and A-rNPCs were evaluated from 0 bar to 30 bar at 23° C. A-rNPC exhibits high CO₂ uptake capacity (1.12 g CO₂/g ArNPC) under a higher pressure environment, which is 5 times higher than Zeolite 5A, and 3 times higher than ZIF-8 under the same conditions. Such CO₂ uptake capacities also exceed about 72 wt % of the CO₂ uptake capacities observed on nitrogen-containing porous carbon (NPC) that were reported in Applicants' pervious patent application (PCT/US2014/044315).

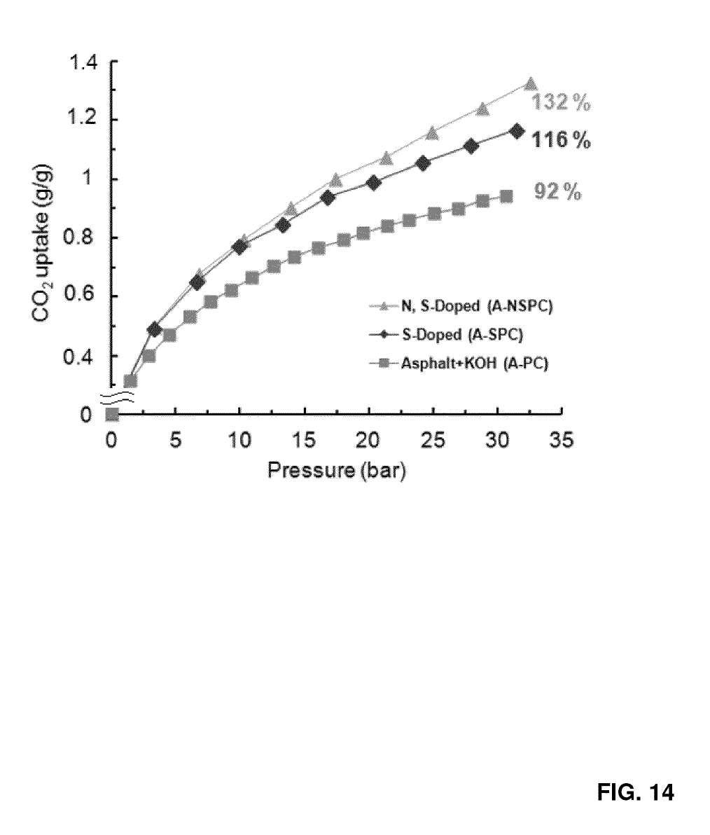

As shown in FIG. 14, the CO₂ uptake capacities of A-SPCs and A-NSPC were also evaluated from 0 to 30 bar at 23° C. The A-NSPCs had been made according to the scheme illustrated in FIG. 2B, where it already completed its life as an H₂S capture material, with air oxidation to a sulfur-rich carbon, then thermalization to form A-SPC, or further exposure to NH₃ to form the A-NSPC. These latter two materials are shown in FIG. 14 to be used for reversible capture of CO₂. This underscores the utility life of these porous carbon materials—first for irreversible capture of H₂S as sulfur in over 200 wt % uptake, and then conversion to A-SPC or A-NSPC for reversible capture of CO₂ in over 100 wt % uptake. A-SPCs exhibited high CO₂ uptake capacities (in excess of 1.10 g CO₂/g A-SPCs) under pressure environment, which is 5 times higher in uptake of CO₂ than Zeolite 5A, and 3 times higher in uptake of CO₂ than ZIF-8 under the same conditions. Such CO₂ uptake capacities also exceed about 89 wt % of the CO₂ uptake capacities observed on sulfur-containing porous carbons (SPC) reported in Applicants' pervious patent application (PCT/US2014/044315).

### Example 3

### Synthesis of Porous Carbon Materials

In this Example, Applicants provide exemplary schemes for the synthesis of porous carbon materials.

### Example 3.1

### Scheme A

Carbon sources suitable for use in the present disclosure are mixed with a vulcanization agent and heated to 180° C. for 12 hours in accordance with the following scheme:

Carbon source+vulcanization agent→porous carbon material

The weight ratio of the vulcanization agent to the carbon source varied from 5 wt % to 200 wt % relative to the carbon source. The vulcanized carbon source obtained was then treated with KOH, as described in Example 2.1.

### Example 3.2

### Scheme B

Carbon sources suitable for use in the present disclosure are mixed with a vulcanization agent and elemental sulfur and heated to about 180° C. for 12 h in accordance with the following scheme:

Carbon source+vulcanization agent+elemental sulfur→porous carbon material

The weight ratio of the vulcanization agent to the carbon source varied from 5 wt % to 200 wt % relative to the carbon source. The obtained vulcanized carbon source was then treated with KOH as described in Example 2.1.

### Example 3.3

### Scheme C

Carbon sources suitable for use in the present disclosure are mixed with a vulcanization agent, elemental sulfur, and KOH in accordance with the following scheme:

Carbon source+vulcanization agent+KOH→porous carbon material

The homogeneous powder is then heated at 600˜800° C. under Ar atmosphere for 1 hour. This is followed by filtration with 10 wt % HCl_{(aq)} and copious amounts of DI water. The weight ratio of the vulcanization agent was chosen from 5 wt % to 200 wt % additive relative to the carbon source. The weight ratio of KOH to the carbon source varied from 1 to 3.

### Example 3.3

### Scheme D

Carbon sources suitable for use in the present disclosure are mixed with a vulcanization agent, elemental sulfur, and KOH in accordance with the following scheme:

Carbon source+vulcanization agent+elemental sulfur+KOH→porous carbon material

The homogeneous powder is then heated at 600˜800° C. under Ar atmosphere for 1 hour. This is followed by filtration with 10 wt % HCl_{(aq)} and copious amounts of DI water. The weight ratio of the elemental sulfur to the carbon source varied from 0.2 to 1. The weight ratio of the vulcanization agent to the carbon source varied from 5 wt % to 200 wt % relative to the carbon source. The weight ratio of KOH to the carbon source was chosen from 1 to 3.

In summary, Applicants have demonstrated in Examples 1-3 the first successful synthesis of microporous active carbons with uniform distribution of pores sizes from asphalt. Applicants subsequently activated the asphalt derived porous carbon materials with nitrogen functional groups. By changing the reaction conditions, the porous carbon materials can possess variable surface areas and nitrogen contents. The CO₂ and H₂S uptake capacities of the asphalt-derived porous carbon materials are higher than other porous carbon materials. Additionally, many of the porous carbon materials derived from asphalt exhibit greater CO₂:CH₄ selectivity than other porous carbon materials. Furthermore, as summarized in Table 4, the carbon sources of the present disclosure are much more affordable than the carbon sources utilized to make other porous carbon materials.

TABLE 4
A comparison of the costs of various carbon sources.

| Carbon Source | Cost |
|---|---|
| 2-thiophene methanol (to make traditional SPC) | $150/100 g (Aldrich) |
| Polyacrylonitrile (to make traditional NPC) | $180/100 g (Aldrich) |
| Whey Protein | $11/lb |
| Rice Protein | $9/lb |
| Coal | $70-150/ton |
| Asphalt | $70-750/ton |

Without further elaboration, it is believed that one skilled in the art can, using the description herein, utilize the present disclosure to its fullest extent. The embodiments described herein are to be construed as illustrative and not as constraining the remainder of the disclosure in any way whatsoever. While the embodiments have been shown and described, many variations and modifications thereof can be made by one skilled in the art without departing from the spirit and teachings of the invention. Accordingly, the scope of protection is not limited by the description set out above, but is only limited by the claims, including all equivalents of the subject matter of the claims. The disclosures of all patents, patent applications and publications cited herein are hereby incorporated herein by reference, to the extent that they provide procedural or other details consistent with and supplementary to those set forth herein.

What is claimed is:

1. A method of capturing a gas from an environment, wherein the method comprises:
associating the environment with a porous carbon material,
wherein the porous carbon material comprises a plurality of pores, and
wherein the porous carbon material is selected from the group consisting of protein-derived porous carbon materials, carbohydrate-derived porous carbon materials, cotton-derived porous carbon materials, fat-derived porous carbon materials, waste-derived porous carbon materials, asphalt-derived porous carbon materials, coal-derived porous carbon materials, coke-derived porous carbon materials, asphaltene-derived porous carbon materials, oil product-derived porous carbon materials, bitumen-derived porous carbon materials, tar-derived porous carbon materials, pitch-derived porous carbon materials, anthracite-derived porous carbon materials, melamine-derived porous carbon materials, and combinations thereof; and
wherein the associating results in sorption of gas components to the porous carbon material,
wherein the sorbed gas components comprise at least one of CO₂, H₂S, and combinations thereof.

2. The method of claim 1, wherein the environment is selected from the group consisting of industrial gas streams, natural gas streams, natural gas wells, industrial gas wells, oil and gas fields, and combinations thereof.

3. The method of claim 1, wherein the environment is a pressurized environment.

4. The method of claim 1, wherein the environment has a total pressure higher than atmospheric pressure.

5. The method of claim 1, wherein the environment has a total pressure of about 5 bar to about 500 bar.

6. The method of claim 1, wherein the associating occurs by placing the porous carbon material at or near the environment.

7. The method of claim 1, wherein the associating occurs by flowing the environment through a structure that contains the porous carbon materials.

8. The method of claim 1, wherein the sorption of the gas components to the porous carbon material occurs by at least one of absorption, adsorption, ionic interactions, physisorption, chemisorption, covalent bonding, non-covalent bonding, hydrogen bonding, van der Waals interactions, acid-base interactions, and combinations thereof.

9. The method of claim 1, wherein the sorption of the gas components to the porous carbon material occurs above atmospheric pressure.

10. The method of claim 1, wherein the sorption of the gas components to the porous carbon material occurs at total pressures ranging from about 5 bar to about 500 bar.

11. The method of claim 1, wherein the sorption of the gas components to the porous carbon material occurs without heating the porous carbon material.

12. The method of claim 1, wherein the sorbed gas components comprise CO₂.

13. The method of claim 12, wherein the sorption of the CO₂ to the porous carbon material occurs at a partial CO₂ pressure of about 0.1 bar to about 100 bar.

14. The method of claim 12, wherein the sorption of the CO₂ to the porous carbon material occurs selectively over hydrocarbons in the environment.

15. The method of claim 14, wherein the molecular ratio of captured CO₂ to captured hydrocarbons in the porous carbon material is greater than about 2

16. The method of claim 12, wherein the CO₂ is converted to poly(CO₂) within the pores of the porous carbon materials.

17. The method of claim 1, wherein the porous carbon material has a CO₂ sorption capacity of about 50 wt % to about 200 wt % of the porous carbon material weight.

18. The method of claim 1, wherein the sorbed gas components comprise H₂S.

19. The method of claim 18, wherein the H₂S is converted within the pores of the porous carbon materials to at least one of elemental sulfur (S), sulfur dioxide (SO₂), sulfuric acid (H₂SO₄), and combinations thereof.

20. The method of claim 18, wherein the sorption of H₂S to the porous carbon material results in conversion of H₂S to elemental sulfur, and wherein the formed elemental sulfur becomes impregnated with the porous carbon material.

21. The method of claim 1, wherein the porous carbon material has a H₂S sorption capacity of about 50 wt % to about 300 wt % of the porous carbon material weight.

22. The method of claim 1, wherein the sorbed gas components comprise CO₂ and H₂S.

23. The method of claim 22, wherein the sorption of H₂S and CO₂ to the porous carbon material occurs at the same time.

24. The method of claim 22, wherein the sorption of CO₂ to the porous carbon material occurs before the sorption of H₂S to the porous carbon material.

25. The method of claim 22, wherein the sorption of H₂S to the porous carbon material occurs before the sorption of CO₂ to the porous carbon material.

26. The method of claim 1, further comprising a step of releasing captured gas components from the porous carbon material.

27. The method of claim 26, wherein the releasing occurs by decreasing the pressure of the environment.

28. The method of claim 26, wherein the releasing occurs by placing the porous carbon material in a second environment, wherein the second environment has a lower pressure than the environment where gas capture occurred.

29. The method of claim 26, wherein the releasing occurs at or below atmospheric pressure.

30. The method of claim 26, wherein the releasing occurs at the same temperature at which gas component sorption occurred.

31. The method of claim 26, wherein the releasing occurs without heating the porous carbon material.

32. The method of claim 26, wherein the releasing occurs by heating the porous carbon material.

33. The method of claim 26, wherein the sorbed gas components comprise CO₂, and wherein the releasing of the CO₂ occurs through depolymerization of formed poly(CO₂).

34. The method of claim 26, wherein the sorbed gas components comprise CO₂, and wherein the releasing of the CO₂ occurs by decreasing the pressure of the environment or placing the porous carbon material in a second environment that has a lower pressure than the environment where CO₂ capture occurred.

35. The method of claim 26, wherein the sorbed gas components comprise H₂S, and wherein the releasing of the H₂S occurs by heating the porous carbon material.

36. The method of claim 26, wherein the sorbed gas components comprise CO₂ and H₂S,
wherein the releasing of the CO₂ occurs by decreasing the pressure of the environment or placing the porous carbon material in a second environment that has a lower pressure than the environment where CO₂ capture occurred, and
wherein the releasing of the H₂S occurs by heating the porous carbon material.

37. The method of claim 36, wherein the releasing of the CO₂ occurs before the releasing of the H₂S.

38. The method of claim 26, further comprising a step of disposing the released gas components.

39. The method of claim 26, further comprising a step of reusing the porous carbon material after the releasing to capture additional gas components from an environment.

40. The method of claim 1, wherein the porous carbon material comprises asphalt-derived porous carbon materials.

41. The method of claim 1, wherein the porous carbon material is carbonized.

42. The method of claim 1, wherein the porous carbon material is reduced.

43. The method of claim 1, wherein the porous carbon material is vulcanized.

44. The method of claim 1, wherein the porous carbon material comprises a plurality of nucleophilic moieties.

45. The method of claim 44, wherein the nucleophilic moieties are selected from the group consisting of oxygen-containing moieties, sulfur-containing moieties, metal-containing moieties, metal oxide-containing moieties, metal sulfide-containing moieties, nitrogen-containing moieties, phosphorous-containing moieties, and combinations thereof.

46. The method of claim 44, wherein the nucleophilic moieties comprise nitrogen-containing moieties, wherein the nitrogen-containing moieties are selected from the group consisting of primary amines, secondary amines, tertiary amines, nitrogen oxides, pyridinic nitrogens, pyrrolic nitrogens, graphitic nitrogens, and combinations thereof.

47. The method of claim 44, wherein the nucleophilic moieties comprise nitrogen-containing moieties and sulfur-containing moieties.

48. The method of claim 1, wherein the porous carbon material has surface areas ranging from about 2,500 m²/g to about 3,000 m²/g.

49. The method of claim 1, wherein the plurality of pores in the porous carbon material comprise diameters ranging from about 1 nm to about 10 nm, and volumes ranging from about 1 cm³/g to about 3 cm³/g.

50. The method of claim 1, wherein the porous carbon material has a density ranging from about 0.3 g/cm³ to about 4 g/cm³.

51. A porous carbon material for gas capture,
wherein the porous carbon material comprises a plurality of pores, and
wherein the porous carbon material is selected from the group consisting of protein-derived porous carbon materials, carbohydrate-derived porous carbon materials, cotton-derived porous carbon materials, fat-derived porous carbon materials, waste-derived porous carbon materials, asphalt-derived porous carbon materials, coal-derived porous carbon materials, coke-derived porous carbon materials, asphaltene-derived porous carbon materials, oil-product derived porous carbon materials, bitumen-derived porous carbon materials, tar-derived porous carbon materials, pitch-derived porous carbon materials, anthracite-derived porous carbon materials, melamine-derived porous carbon materials, and combinations thereof.

52. The porous carbon material of claim 51, wherein the porous carbon material has a CO₂ sorption capacity of about 50 wt % to about 200 wt % of the porous carbon material weight.

53. The porous carbon material of claim 51, wherein the porous carbon material has a H₂S sorption capacity of about 50 wt % to about 300 wt % of the porous carbon material weight.

54. The porous carbon material of claim 51, wherein the porous carbon material comprises asphalt-derived porous carbon materials.

55. The porous carbon material of claim 51, wherein the porous carbon material is carbonized.

56. The porous carbon material of claim 51, wherein the porous carbon material is reduced.

57. The porous carbon material of claim 51, wherein the porous carbon material is vulcanized.

58. The porous carbon material of claim 51, wherein the porous carbon material comprises a plurality of nucleophilic moieties.

59. The porous carbon material of claim 58, wherein the nucleophilic moieties are selected from the group consisting of oxygen-containing moieties, sulfur-containing moieties, metal-containing moieties, metal oxide-containing moieties, metal sulfide-containing moieties, nitrogen-containing moieties, phosphorous-containing moieties, and combinations thereof.

60. The porous carbon material of claim 58, wherein the nucleophilic moieties comprise nitrogen-containing moieties, wherein the nitrogen-containing moieties are selected from the group consisting of primary amines, secondary amines, tertiary amines, nitrogen oxides, pyridinic nitrogens, pyrrolic nitrogens, graphitic nitrogens, and combinations thereof.

61. The porous carbon material of claim 58, wherein the nucleophilic moieties comprise nitrogen-containing moieties and sulfur-containing moieties.

62. The porous carbon material of claim 58, wherein the porous carbon material has surface areas ranging from about 2,500 m²/g to about 3,000 m²/g.

63. The porous carbon material of claim 51, wherein the plurality of pores in the porous carbon material comprise diameters ranging from about 1 nm to about 10 nm, and volumes ranging from about 1 cm³/g to about 3 cm³/g.

64. The porous carbon material of claim 51, wherein the porous carbon material has a density ranging from about 0.3 g/cm³ to about 4 g/cm³.

65. A method of forming a porous carbon material comprising a plurality of pores, wherein the method comprises:
carbonizing a carbon source,
wherein the carbon source is selected from the group consisting of protein, carbohydrates, cotton, fat, waste, asphalt, coal, coke, asphaltene, oil products, bitumen, tar, pitch, anthracite, melamine, and combinations thereof, and
and wherein the carbonizing results in formation of the porous carbon material.

66. The method of claim 65, wherein the carbonizing occurs in the absence of a solvent.

67. The method of claim 65, wherein the carbonizing occurs by exposing the carbon source to a carbonization agent.

68. The method of claim 67, wherein the carbonization agent is selected from the group consisting of metal hydroxides, metal oxides, potassium hydroxide (KOH), sodium hydroxide (NaOH), lithium hydroxide (LiOH), cesium hydroxide (CsOH), magnesium hydroxide (Mg(OH)₂), calcium hydroxide (Ca(OH)₂), and combinations thereof.

69. The method of claim 67, wherein the exposing occurs by grinding the carbon source in the presence of a carbonization agent.

70. The method of claim 65, wherein the carbonizing occurs by heating the carbon source at temperatures ranging from about 200° C. to about 800° C.

71. The method of claim 65, further comprising a step of doping the carbon source with a dopant.

72. The method of claim 71, wherein the dopant is selected from the group consisting of nitrogen-containing dopants, sulfur-containing dopants, heteroatom-containing dopants, oxygen-containing dopants, sulfur-containing dopants, metal-containing dopants, metal oxide-containing dopants, metal sulfide-containing dopants, phosphorous-containing dopants, and combinations thereof.

73. The method of claim 65, further comprising a step of vulcanizing the carbon source.

74. The method of claim 65, wherein the formed porous carbon material is selected from the group consisting of protein-derived porous carbon materials, carbohydrate-derived porous carbon materials, cotton-derived porous carbon materials, fat-derived porous carbon materials, waste-derived porous carbon materials, asphalt-derived porous carbon materials, coal-derived porous carbon materials, coke-derived porous carbon materials, asphaltene-derived porous carbon materials, oil product-derived porous carbon materials, bitumen-derived porous carbon materials, tar-derived porous carbon materials, pitch-derived porous carbon materials, anthracite-derived porous carbon materials, melamine-derived porous carbon materials, and combinations thereof.

75. The method of claim 65, wherein the carbon source comprises asphalt, and wherein the formed porous carbon material comprises asphalt-derived porous carbon materials.

76. The method of claim 65, further comprising a step of reducing the formed porous carbon material.

77. The method of claim 76, wherein the reducing occurs by exposing the formed porous carbon material to a reducing agent.
